(19) United States
(12) Patent Application Publication
(10) Pub. No.: US 2022/0266236 A1
(43) Pub. Date: Aug. 25, 2022

(54) CATALYST SYSTEMS AND METHODS OF USE

(71) Applicants: Saudi Arabian Oil Company, Dhahran (SA); King Fahd University of Petroleum and Minerals, Dhahran (SA)

(72) Inventors: Emad Al-Shafei, Dhahran (SA); Oki Muraza, Dhahran (SA); Mohammed Ahmed Sanhoob, Dhahran (SA); Mohammed Z. Al-Bahar, Dhahran (SA); Ki-Hyouk Choi, Dhahran (SA); Zain Hassan Yamani, Dhahran (SA); Ali S. Al-Nasir, Dhahran (SA)

(73) Assignees: Saudi Arabian Oil Company, Dhahran (SA); King Fahd University of Petroleum and Minerals, Dhahran (SA)

(21) Appl. No.: 17/185,286

(22) Filed: Feb. 25, 2021

(51) Int. Cl. B01J 37/10; B01J 37/34; C01B 39/12; C01B 39/04; B01J 6/00; B01J 29/86; B01J 35/00

(52) U.S. Cl. CPC B01J 37/10; B01J 37/346; C01B 39/12; C01B 39/04; B01J 6/001; B01J 29/86; B01J 35/006; C01P 2004/61; C01P 2004/03

(57) ABSTRACT

According to embodiments, methods for the production of boron-silicalite-1 are disclosed. In embodiments, the method may include combining a mineralizer agent, a templating agent, water, and boric acid in a first microwave unit; heating the first microwave unit to form a boron-zeolite; calcining the boron-zeolite to form an alkali-zeolite; combining the alkali-zeolite with ammonium nitrate to produce an ion-exchanged zeolite; heating the ion-exchanged zeolite to form a protonated zeolite; and calcining the protonated zeolite to form the boron-silicalite-1. In embodiments, the method may include combining a templating agent, water, and boric acid in a first hydrothermal unit; heating the first microwave unit to form a boron-zeolite; calcining the boron-zeolite to form an alkali-zeolite; combining the alkali-zeolite with ammonium nitrate to produce an ion-exchanged zeolite; heating the ion-exchanged zeolite to form a protonated zeolite; and calcining the protonated zeolite to form the boron-silicalite-1. The boron-silicalite-1 may be microscale or nanoscale.

### TECHNICAL FIELD

Embodiments of the present disclosure generally relate to zeolite catalysts and more specifically relate to methods of producing zeolite catalysts.

### BACKGROUND

Zeolite catalysts have widespread uses in many diverse industries. Exemplary industries include the petrochemical industry in refinery, gas separation, and carbon dioxide separation and capture processes. In the petroleum industry, for example, zeolite catalysts may be included in processes such as fluid catalytic cracking (FCC) and hydrocracking to catalyze reactions such as hydrogenation, dehydrogenation, isomerization, alkylation, and cracking, for example.

### SUMMARY

These industry processes each share constant needs for developing zeolite catalysts with goals such as increased activity and increased shape selectivity. For example, a boron-silicalite-1 catalyst may be utilized, where boron may be incorporated into the zeolite framework to produce a catalyst having increased surface acidity. However, conventional methods of producing boron-silicalite-1 typically last days (i.e. 48 hours) for crystallization to occur and may require the use of organic solvents, such as ethanol, in an attempt to reduce the average crystal size. Accordingly, ongoing needs exist for production methods that may shorten the crystallization time of boron-silicalite-1 and may not require the use of organic solvents, such as ethanol.

Embodiments of the present disclosure meet those needs by providing methods that utilize one or more microwave or hydrothermal treatment steps in combination with one or more calcination steps. The microwave or hydrothermal treatment steps may have a direct impact on producing a microscale or nanoscale boron-silicalite-1 having an average crystal size of from 1 micrometers to 5 micrometers or 200 nanometers to 400 nanometers, respectively. Furthermore, the microwave or hydrothermal treatment steps may have a direct impact on producing a microscale or nanoscale boron-silicalite-1 without requiring the use additional organic solvents, such as ethanol. Moreover, the systems described herein may allow for production methods with relatively shorter crystallization times (i.e., hours rather than days).

According to one or more embodiments, a method for the production of microscale boron-silicalite-1 is provided. The method may include combining a mineralizer agent, a templating agent, water, and boric acid in a first microwave unit; heating the first microwave unit to form a boron-zeolite; calcining the boron-zeolite to form an alkali-zeolite; combining the alkali-zeolite with ammonium nitrate to produce an ion-exchanged zeolite; heating the ion-exchanged zeolite to form a protonated zeolite; and calcining the protonated zeolite to form the microscale boron-silicalite-1. The microscale boron-silicalite-1 may have an average crystal size of from 1 micrometers to 5 micrometers when measured according to Scanning Electron Microscopy (SEM).

According to one or more embodiments, a method for the production of boron-silicalite-1 is provided. The method may include combining a templating agent, water, and boric acid in a first hydrothermal unit; heating the first microwave unit to form a boron-zeolite; calcining the boron-zeolite to form an alkali-zeolite; combining the alkali-zeolite with ammonium nitrate to produce an ion-exchanged zeolite; heating the ion-exchanged zeolite to form a protonated zeolite; and calcining the protonated zeolite to form the boron-silicalite-1. The boron-silicalite-1 may have an average crystal size of from 1 micrometers to 5 micrometers when measured according to scanned electron microscope. The boron-silicalite-1 may have an average crystal size of from 200 nanometers to 400 nanometers when measured according to Scanning Electron Microscopy (SEM).

Additional features and advantages of the present embodiments will be set forth in the detailed description which follows, and in part will be readily apparent to those skilled in the art from that description or recognized by practicing the described embodiments, including the detailed description which follows, the claims, as well as the appended drawings.

### BRIEF DESCRIPTION OF THE DRAWINGS

FIG. 1 is a schematic depiction of a system for producing boron-silicalite-1 in accordance with one or more embodiments;

FIG. 2 is a schematic depiction of a system for producing boron-silicalite-1 in accordance with one or more embodiments;

FIG. 3 is a schematic depiction of a system for producing boron-silicalite-1 in accordance with one or more embodiments;

FIG. 4 is a schematic depiction of a FIG system for producing boron-silicalite-1 in accordance with one or more embodiments;

FIG. 5 is a Scanning Electron Microscopy (SEM) image of a microscale boron-silicalite-1 made by a system for producing boron-silicalite-1 in accordance with one or more embodiments; and

FIG. 6 is a Scanning Electron Microscopy (SEM) image of a nanoscale boron-silicalite-1 made by a system for producing boron-silicalite-1 in accordance with one or more embodiments.

### DETAILED DESCRIPTION

Generally described in this disclosure are various embodiments of systems and methods for producing boron-silicalite-1. According to one or more embodiments, the disclosed processes may include one or more microwave treatment steps and calcination steps. According to one or more embodiments, the disclosed processes may include one or more hydrothermal treatment steps and calcination steps. The processes presently described may allow for the production of nanoscale boron-silicalite-1 and microscale boron-silicalite-1. The processes presently described may allow for the production of boron-silicalite-1 zeolite having a boron trigonal coordination structure.

As used herein, a “microscale boron-silicalite-1” may be a boron-silicalite-1 having an average crystal size of from 1 micrometers to 5 micrometers when measured according to Scanning Electron Microscopy (SEM).

As used herein, a “nanoscale boron-silicalite-1” may be a boron-silicalite-1 having an average crystal size of from 200 nanometers to 400 nanometers when measured according to Scanning Electron Microscopy (SEM).

Microwave Systems

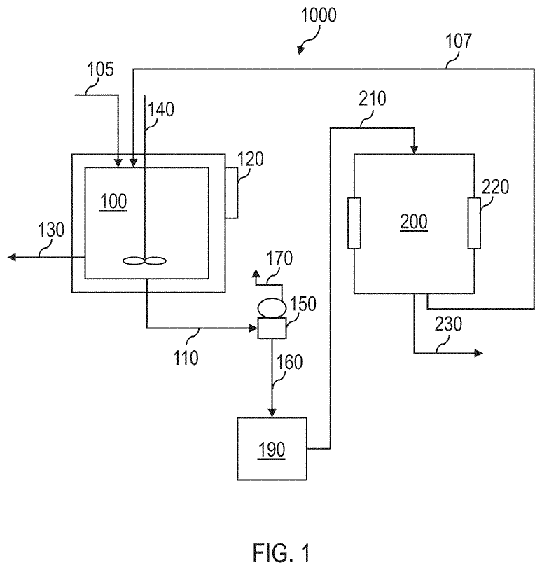

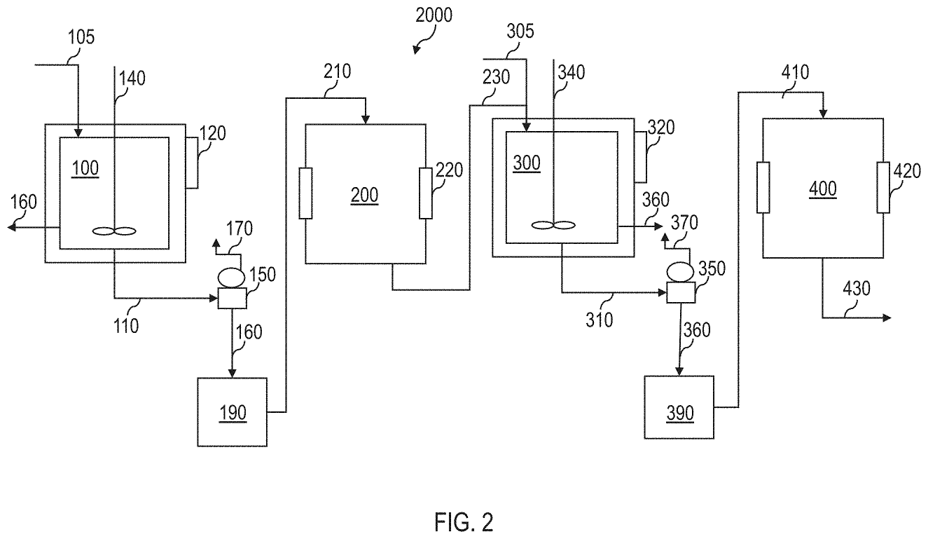

Embodiments of systems for producing boron-silicalite-1 that may include one or more microwave treatment steps and calcination steps will now be described. FIGS. 1 and 2 each depict an embodiment of a system that utilizes one and two microwave irradiation oven(s), respectively. In embodiments, the incorporation of the microwave irradiation oven may allow for the production of microscale of boron-silicalite-1. As shown in FIG. 1, the system 1000 for producing boron-silicalite-1 may include a first microwave unit 100 and a first calcination unit 200. As shown in FIG. 2, the system 2000 for producing boron-silicalite-1 may include a first microwave unit 100, a first calcination unit 200, a second microwave unit 300, and a second calcination unit 400.

The first microwave unit 100 may be utilized to promote crystallization. Referring now to FIG. 1, embodiments of the system 1000 include a feed that may enter the first microwave unit 100 via a line 105. The feed, in embodiments, may include a mineralizer agent, a templating agent, water, and boric acid. In embodiments, the mineralizer agent, the templating agent, the water, and the boric acid may be fed separately to the first microwave unit 100, fed together to the first microwave unit 100, or fed to the first microwave unit 100 in various combinations as described herein. As used herein, the mineralizer agent may be an aqueous metal hydroxide solution. The aqueous metal hydroxide solution may include a single metal hydroxide species or may be a combination of two or more metal hydroxide chemical species. In embodiments, the aqueous metal hydroxide solution comprises at least one alkali metal hydroxide, at least one alkali earth metal hydroxide, or combinations thereof. The aqueous metal hydroxide solution may comprise lithium hydroxide (LiOH), sodium hydroxide (NaOH), potassium hydroxide (KOH), rubidium hydroxide (RbOH), magnesium hydroxide (Mg(OH)₂), calcium hydroxide (Ca(OH)₂), strontium hydroxide (Sr(OH)₂), barium hydroxide (Ba(OH)₂), or combinations thereof. In some embodiments, the mineralizer agent utilized may include sodium hydroxide, potassium hydroxide, or both. Templating agents may include, by way of non-limiting example, hydrocarbon polymers, nitrogen doped hydrocarbon polymers, tetraethylammonium hydroxide, imethoxsilylpropyldimethyloctadecyl ammonium chloride, tetrapropyl ammonium hydroxide, cetyltrimethylammonium bromide, or combinations thereof. In embodiments, the feed may also include pore-directing agents, which may include cationic surfactants and non-ionic surfactants. Cationic surfactant pore-directing agents may include, by way of non-limiting example, dodecyltrimethylammonium, cetyltrimethylammonium, propyltrimethylammonium, tetraethylammonium, tetrapropylammonium, octyltrimethylammonium, or combinations thereof. Non-ionic surfactant pore-directing agents may include, by way of non-limiting example, monoamines, polyamines, or combinations thereof. In embodiments, the feed may further include water. In particular embodiments, the water may be deionized water.

In embodiments, water and the mineralizer agent may be introduced into the first microwave unit 100 via the line 105 and subsequently mixed to produce a mineralizer solution. Mixing may include one or more of stirring, swirling, vortexing, shaking, sonicating, homogenizing, blending, or the like. In embodiments, the water and the mineralizer agent may then be mixed via a first stirrer 140 until the mineralizer solution is homogenous. Without being limited by any particular theory, it is believed that mixing the water and the mineralizer agent may evenly disperse the mineralizer agent within the water to produce the homogenous mineralizer solution. In embodiments, the water and the mineralizer agent may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm.

Once the water and the mineralizer agent are sufficiently mixed to produce the mineralizer solution, the templating agent may be introduced into the first microwave unit 100 via the line 105 to be mixed with the mineralizer solution. The templating agent may be utilized to facilitate the formation of the MFI structure within the silicalite-1. Once the templating agent is introduced into the first microwave unit 100, the templating agent and mineralizer solution may be mixed via a first stirrer 140 to produce a synthesis mixture. In embodiments, the templating agent and mineralizer solution may be mixed via the first stirrer 140 until a homogenous synthesis mixture is produced. Without being limited by any particular theory, it is believed that mixing the templating agent and the mineralizer solution may evenly disperse the templating agent within the mineralizer solution to produce the homogenous synthesis mixture. In embodiments, the templating agent and mineralizer solution may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. In embodiments, the templating agent and mineralizer solution may be mixed for a time from 1 minute to 15 minutes, from 1 minute to 10 minutes, from 1 minute to 5 minutes, from 5 minutes to 15 minutes, from 5 minutes to 10 minutes, or from 10 minutes to 15 minutes.

Once the synthesis mixture is produced, a silicon compound may be introduced into the first microwave unit 100 via line 105. In one or more embodiments, the silicon compound may comprise silica, sodium silicate, colloidal silica, fumed silica, or combinations thereof. In one embodiment, the silicon compound comprises colloidal silica. In some embodiments, once the synthesis mixture is produced, colloidal silica may be introduced into the first microwave unit 100 via line 105. The colloidal silica may be from 20 percent by weight (wt. %) to 50 wt. %, from 20 wt. % to 40 wt. %, from 20 wt. % to 30 wt. %, from 30 wt. % to 50 wt. %, from 30 wt. % to 40 wt. %, or from 40 wt. % to 50 wt. % suspension in water based on the total weight of the colloidal silica. Once the silicon compound is introduced into the first microwave unit 100, the silicon compound and synthesis mixture may be mixed via the first stirrer 140 to produce a zeolite solution. In embodiments, the silicon compound and synthesis mixture may be mixed via the first stirrer 140 until a homogenous zeolite solution is produced. In embodiments, the silicon compound and synthesis mixture may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. In embodiments, the silicon compound and synthesis mixture may be mixed for a time from 1 minute to 15 minutes, from 1 minute to 10 minutes, from 1 minute to 5 minutes, from 5 minutes to 15 minutes, from 5 minutes to 10 minutes, or from 10 minutes to 15 minutes.

Once the zeolite solution is produced, boric acid may be introduced into the first microwave unit 100 via line 105. The presently-disclosed methods may allow for flexibility with respect to the boron content of the final boron-silicalite-1, which may be adjusting the amount of boric acid added. In embodiments, the boric acid may be added in an amount so that the silicon to boron ratio is from 5 to 5000, from 5 to 1000, from 5 to 500, from 5 to 100, from 5 to 50, or from 5 to 10 in the first microwave unit 100. The boric acid may be added in an amount so that the silicon to boron ratio is 10 in the first microwave unit 100. Once the boric acid is introduced into the first microwave unit 100, the boric acid and zeolite solution may be mixed via the first stirrer 140 to produce a boron-zeolite solution. In embodiments, the boric acid and zeolite solution may be mixed via the stirrer 140 until a homogenous boron-zeolite solution is produced. In embodiments, the boric acid and zeolite solution may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. In embodiments, the boric acid and zeolite solution may be mixed for a time from 30 minutes to 5 hours, from 30 minutes to 4 hours, from 30 minutes to 3 hours, from 30 minutes to 2 hours, from 30 minutes to 1 hour, from 1 hour to 5 hours, from 1 hour to 4 hours, from 1 hour to 3 hours, from 1 hour to 2 hours, from 2 hours to 5 hours, from 2 hours to 4 hours, from 2 hours to 3 hours, from 3 hours to 5 hours, from 3 hours to 4 hours, or from 4 hours to 5 hours.

In embodiments, heat may be applied to the first microwave unit 100 via a first microwave irradiation element 120 to accelerate crystallization of the boron-zeolite solution to form boron-silicalite-1. In embodiments, the first microwave unit 100 may be heated to a crystallization temperature of from 165° C. to 185° C., from 165° C. to 180° C., from 165° C. to 175° C., from 165° C. to 170° C., from 170° C. to 185° C., from 170° C. to 180° C., from 170° C. to 175° C., from 175° C. to 185° C., from 175° C. to 180° C., or from 180° C. to 185° C. In embodiments, as heat is applied via the first microwave irradiation element 120, the first microwave unit 100 may be mixed at a crystallization stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. As heat is applied via the first microwave irradiation element 120 the first microwave unit 100 may be operated at the crystallization temperature and the crystallization stirring speed for a crystallization time period of from 0.5 hours to 2.5 hours, from 0.5 hours to 2.0 hours, from 0.5 hours to 1.5 hours, from 0.5 hours to 1.0 hour, from 1.0 hour to 2.5 hours, from 1.0 hour to 2.0 hours, from 1.0 hour to 1.5 hours, from 1.5 hours to 2.5 hours, from 1.5 hours to 2.0 hours, or from 2.0 hours to 2.5 hours.

Next, the boron-zeolite solution within the first microwave unit 100 may be cooled to a temperature of from 15° C. to 35° C., from 15° C. to 30° C., from 15° C. to 25° C., from 15° C. to 20° C., from 20° C. to 35° C., from 20° C. to 30° C., from 20° C. to 25° C., from 20° C. to 25° C., from 25° C. to 35° C., from 25° C. to 30° C., or from 30° C. to 35° C. Once the boron-zeolite solution has cooled, the solid phase of the boron-zeolite solution comprising zeolite powder may settle in the solution, and the liquid phase of the boron-zeolite solution (i.e. without the zeolite powder) may be evacuated through line 130.

In embodiments, the zeolite powder remaining in the first microwave unit 100 may be washed. To wash the zeolite power, an amount of water sufficient to wash the zeolite powder may be fed into the first microwave unit 100 via line 105. In embodiments, the amount of water sufficient to wash the zeolite powder may be in a range of from 50 kg to 200 kg, from 50 kg to 150 kg, from 50 kg to 100 kg, from 100 kg to 200, from 100 kg to 150 kg, or from 150 kg to 200 kg. Once the water has been added, the first microwave unit 100 may be stirred via the first stirrer 140 at a speed of from 100 rpm to 200 rpm, from 100 rpm to 180 rpm, from 100 rpm to 160 rpm, from 100 rpm to 140 rpm, from 100 rpm to 120 rpm, from 120 rpm to 200 rpm, from 120 rpm to 180 rpm, from 120 rpm to 160 rpm, from 120 rpm to 140 rpm, from 140 rpm to 200 rpm, from 140 rpm to 180 rpm, from 140 rpm to 160 rpm, from 160 rpm to 200 rpm, from 160 rpm to 180 rpm, or from 180 rpm to 200 rpm. In embodiments, the first microwave unit 100 may be stirred for a time period sufficient to wash the zeolite powder, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

Once the zeolite powder has been washed, the zeolite powder in solution (comprised of the washing water) may be evacuated via line 110 to a first centrifuge unit 150 to separate the aqueous phase of the solution (comprising the washing water) from the solid phase of the solution (comprising the zeolite powder). Once separated, the solid phase (comprising the zeolite powder) may be evacuated from the first centrifuge unit 150 via line 160, and the aqueous phase (comprising the washing water) may be evacuated from the first centrifuge unit 150 via line 170. In embodiments, the first centrifuge unit 150 may be operated at a speed of from 2500 rpm to 3500 rpm, from 2500 rpm to 3250 rpm, from 2500 rpm to 3000 rpm, from 2500 rpm to 2750 rpm, from 2750 rpm to 3500 rpm, from 2750 rpm to 3250 rpm, from 2750 rpm to 3000 rpm, from 3000 rpm to 3500 rpm, from 3000 rpm to 3250 rpm, or from 3250 rpm to 3500 rpm. In embodiments, the first centrifuge unit 150 may be operated at a flow rate of from 0.05 kg/min to 0.20 kg/min, from 0.05 kg/min to 0.15 kg/min, from 0.05 kg/min to 0.10 kg/min, from 0.10 kg/min to 0.20 kg/min, from 0.10 kg/min to 0.15 kg/min, or from 0.15 kg/min to 0.20 kg/min.

Once evacuated from the first centrifuge unit 50, the solid phase (comprising the zeolite powder) may be passed to a first zeolite powder collector 190 before being passed via line 210 to a first calcination unit 200.

In embodiments, the zeolite powder may be heated in the calcination unit 200 to dry any remaining water from the zeolitepowder. In embodiments, the zeolite powder may be heated in the first calcination unit 200 at a temperature and for a time period sufficient to dry any remaining water from the zeolite powder at a constant temperature. In embodiments, the first calcination unit 220 may be heated via a first heating element 220. In further embodiments, the first heating element 220 may be an electric heater. The first heating element 220 may heat the first calcination unit 200 at a heating rate of from 10° C./minute to 30° C./minute, from 10° C./minute to 25° C./minute, from 10° C./minute to 20° C./minute, from 10° C./minute to 15° C./minute, from 15° C./minute to 30° C./minute, from 15° C./minute to 25° C./minute, from 15° C./minute to 20° C./minute, from 20° C./minute to 30° C./minute, from 20° C./minute to 25° C./minute, or from 25° C./minute to 30° C./minute to reach the drying temperature. The drying temperature may be a temperate of from 10° C. to 30° C., from 10° C. to 25° C., from 10° C. to 20° C., from 10° C. to 15° C., from 15° C. to 30° C., from 15° C. to 25° C., from 15° C. to 20° C., from 20° C. to 30° C., from 20° C. to 25° C., or from 25° C. to 30° C. In embodiments, the zeolite powder may be heated in the first calcination unit 200 for a time period sufficient to dry any remaining water from the zeolite powder, for example, from 5 hours to 15 hours, from 5 hours to 13 hours, from 5 hours to 11 hours, from 5 hours to 9 hours, from 5 hours to 7 hours, from 7 hours to 15 hours, from 7 hours to 13 hours, from 7 hours to 11 hours, from 7 hours to 9 hours, from 9 hours to 15 hours, from 9 hours to 13 hours, from 9 hours to 11 hours, from 11 hours to 15 hours, from 11 hours to 13 hours, or from 13 hours to 15 hours.

After the zeolite powder has been dried, it may be calcined in the first calcination unit 200 to produce an alkali-zeolite. The first calcination unit 200 may be operated at a calcination temperature from 500° C. to 600° C., from 500° C. to 580° C., from 500° C. to 560° C., from 500° C. to 540° C., from 500° C. to 520° C., from 520° C. to 600° C., from 520° C. to 580° C., from 520° C. to 560° C., from 520° C. to 540° C., from 540° C. to 600° C., from 540° C. to 580° C., from 540° C. to 560° C., from 560° C. to 600° C., from 560° C. to 580° C. or from 590° C. to 600° C. In embodiments, the zeolite powder may be calcined in the first calcination unit 200 for a time period sufficient to calcine the zeolite powder, for example, from 4 hours to 10 hours, from 4 hours to 8 hours, from 4 hours to 6 hours, from 6 hours to 10 hours, from 6 hours to 8 hours, or from 8 hours to 10 hours. Without being bound by theory, calcining the zeolite powder may burn off any templating or pore directing agents to form mesopores on the zeolite.

After completing the calcination, the alkali-zeolite may be cooled down to a temperature of from 20° C. to 50° C., from 20° C. to 40° C., from 20° C. to 30° C., from 30° C. to 50° C., from 30° C. to 40° C., or from 40° C. to 50° C.

Once the alkali-zeolite has been produced, in some embodiments, the alkali-zeolite may be evacuated from the first calcination unit 200. In embodiments, the alkali-zeolite may be manually evacuated from the first calcination unit 200 via line 230 and passed back to the first microwave unit 100 via line 105. In other embodiments, the alkali-zeolite may be evacuated from the first calcination unit 200 and passed back to the first microwave unit 100 via a recycle line 107.

Subsequently, an ammonium nitrate solution may be introduced into the microwave unit 100 via line 105. Alternatively, ammonia hydroxide may be utilized interchangeably with ammonium nitrate in this disclosure. In embodiments, the ammonium nitrate solution may have a molarity of from 1.0 M to 2.0 M, from 1.0 M to 1.8 M, from 1.0 M to 1.6 M, from 1.0 M to 1.4 M, from 1.0 M to 1.2 M, from 1.2 M to 2.0 M, from 1.2 M to 1.8 M, from 1.2 M to 1.6 M, from 1.2 M to 1.4 M, from 1.4 M to 2.0 M, from 1.4 M to 1.8 M, from 1.4 M to 1.6 M, from 1.6 M to 2.0 M, from 1.6 M to 1.8 M, or from 1.8 M to 2.0 M.

In embodiments, the weight ratio of the alkali-zeolite to ammonium nitrate solution may be from 1:5 to 1:10, from 1:5 to 1:9, from 1:5 to 1:8, from 1:5 to 1:7, from 1:5 to 1:6, from 1:6 to 1:10, from 1:6 to 1:9, from 1:6 to 1:8, from 1:6 to 1:7, from 1:7 to 1:10, from 1:7 to 1:9, from 1:7 to 1:8, from 1:8 to 1:10, from 1:8 to 1:9, or from 1:9 to 1:10.

To produce an ion-exchanged zeolite solution, the alkali-zeolite and ammonium nitrate solution may be stirred in the first microwave unit 100 via the first stirrer 140 at a speed of from 280 rpm to 320 rpm, from 280 rpm to 310 rpm, from 280 rpm to 300 rpm, from 280 rpm to 290 rpm, from 290 rpm to 320 rpm, from 290 rpm to 310 rpm, from 290 rpm to 300 rpm, from 300 rpm to 320 rpm, from 300 rpm to 310 rpm, or from 310 rpm to 320 rpm. In embodiments, the first microwave unit 100 may be stirred for a time period sufficient to produce the ion-exchanged zeolite solution, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes. Without being bound by theory, the ion-exchange step may produce a reactive zeolite by exchanging ammonia ions for the alkali ions of the alkali-zeolite.

To produce a protonated zeolite solution, heat may be applied to the first microwave unit 100 via the first microwave irradiation element 120. Without being bound by theory, the protonation step may produce a reactive zeolite by producing a hydrogen form of the ion-exchanged zeolite. The alkali zeolite has been ion-exchanged using the ammonium nitrate or ammonia hydroxide, as a source of proton to obtain the protonated form (hydrogen form of the zeolite) In embodiments, the first microwave unit 100 may be heated to a protonation temperature of from 65° C. to 90° C., from 65° C. to 85° C., from 65° C. to 80° C., from 65° C. to 75° C., from 65° C. to 70° C., from 70° C. to 85° C., from 70° C. to 80° C., from 70° C. to 75° C., from 75° C. to 85° C., from 75° C. to 80° C., or from 80° C. to 85° C. In embodiments, as heat is applied via the first microwave irradiation element 120, the first microwave unit 100 may be mixed at a protonation stirring speed of from 350 revolutions per minute (rpm) to 400 rpm, from 350 rpm to 390 rpm, from 350 rpm to 380 rpm, from 350 rpm to 370 rpm, from 350 rpm to 360 rpm, from 360 rpm to 400 rpm, from 360 rpm to 390 rpm, from 360 rpm to 380 rpm, from 360 rpm to 370 rpm, from 370 rpm to 400 rpm, from 370 rpm to 390 rpm, from 370 rpm to 380 rpm, from 380 rpm to 400 rpm, from 380 rpm to 390 rpm, or from 390 rpm to 400 rpm. As heat is applied via the first microwave irradiation element 120 the first microwave unit 100 may be operated at the protonation temperature and the protonation stirring speed for a protonation time period of from 5 minutes to 15 minutes, from 5 minutes to 10 minutes, or from 10 minutes to 15 minutes.

Next, the protonated zeolite solution within the first microwave unit 100 may be cooled to a temperature of from 15° C. to 35° C., from 15° C. to 30° C., from 15° C. to 25° C., from 15° C. to 20° C., from 20° C. to 35° C., from 20° C. to 30° C., from 20° C. to 25° C., from 20° C. to 25° C., from 25° C. to 35° C., from 25° C. to 30° C., or from 30° C. to 35° C. Once the protonated zeolite solution has cooled, the solid phase of the protonated zeolite solution comprising the protonated zeolite powder may settle in the solution, and the liquid phase of the protonated zeolite solution (i.e. the washing water without the protonated zeolite powder) may be evacuated through line 130.

In embodiments, the protonated zeolite powder remaining in the first microwave unit 100 may be washed. To wash the protonated zeolite powder, an amount of water sufficient to wash the protonated zeolite powder may be fed into the first microwave unit 100 via line 105. In embodiments, the ratio of the amount of water to the protonated zeolite powder may be in a range of from 1:5 to 1:15, from 1:5 to 1:10, or from 1:10 to 1:15. Once the water has been added, the first microwave unit 100 may be stirred via the first stirrer 140 at a speed of from 100 rpm to 200 rpm, from 100 rpm to 180 rpm, from 100 rpm to 160 rpm, from 100 rpm to 140 rpm, from 100 rpm to 120 rpm, from 120 rpm to 200 rpm, from 120 rpm to 180 rpm, from 120 rpm to 160 rpm, from 120 rpm to 140 rpm, from 140 rpm to 200 rpm, from 140 rpm to 180 rpm, from 140 rpm to 160 rpm, from 160 rpm to 200 rpm, from 160 rpm to 180 rpm, or from 180 rpm to 200 rpm. In embodiments, the first microwave unit 100 may be stirred for a time period sufficient to wash the protonated zeolite powder, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

In embodiments, one or more of the ion-exchange, protonation, and washing steps may be repeated. In some embodiments, each step may be repeated consecutively or the entire sequence (for example one ion-exchange step, one protonation step, and one washing step) may be repeated after one sequence is complete. In embodiments, each step may be repeated 2, 3, or more times. For example, in embodiments, the methods disclosed herein may include an ion-exchange step, a protonation step, and a washing step, then an additional ion-exchange step, an additional protonation step, and an additional washing step.

Once the protonated zeolite powder has been washed, the protonated zeolite powder in solution (comprised of the washing water) may be evacuated via line 110 to a first centrifuge unit 150 to separate the aqueous phase of the solution (comprising the washing water) from the solid phase of the solution (comprising the protonated zeolite powder). Once separated, the solid phase (comprising the protonated zeolite powder) may be evacuated from the first centrifuge unit 150 via line 160, and the aqueous phase (comprising the washing water) may be evacuated from the first centrifuge unit 150 via line 170. In embodiments, the first centrifuge unit 150 may be operated at a speed of from 2500 rpm to 3500 rpm, from 2500 rpm to 3250 rpm, from 2500 rpm to 3000 rpm, from 2500 rpm to 2750 rpm, from 2750 rpm to 3500 rpm, from 2750 rpm to 3250 rpm, from 2750 rpm to 3000 rpm, from 3000 rpm to 3500 rpm, from 3000 rpm to 3250 rpm, or from 3250 rpm to 3500 rpm. In embodiments, the first centrifuge unit 150 may be operated at a flow rate of from 0.05 kg/min to 0.20 kg/min, from 0.05 kg/min to 0.15 kg/min, from 0.05 kg/min to 0.10 kg/min, from 0.10 kg/min to 0.20 kg/min, from 0.10 kg/min to 0.15 kg/min, or from 0.15 kg/min to 0.20 kg/min.

Once evacuated from the first centrifuge unit 150, the solid phase (comprising the protonated zeolite powder) may be passed to the first zeolite powder collector 190 before being passed via line 210 to the first calcination unit 200.

In embodiments, the protonated zeolite powder may be heated in the first calcination unit 200 to dry any remaining water from the protonated zeolite powder. In embodiments, the protonated zeolite powder may be heated in the first calcination unit 200 at a temperature and for a time period sufficient to dry any remaining water from the protonated zeolite powder at a constant temperature. In embodiments, the first heating element 220 may be an electric heater. The first heating element 220 may heat the first calcination unit 200 at a heating rate of from 10° C./minute to 30° C./minute, from 10° C./minute to 25° C./minute, from 10° C./minute to 20° C./minute, from 10° C./minute to 15° C./minute, from 15° C./minute to 30° C./minute, from 15° C./minute to 25° C./minute, from 15° C./minute to 20° C./minute, from 20° C./minute to 30° C./minute, from 20° C./minute to 25° C./minute, or from 25° C./minute to 30° C./minute to reach the drying temperature. The drying temperature may be a temperate of from 90° C. to 115° C., from 90° C. to 110° C., from 90° C. to 105° C., from 90° C. to 100° C., from 90° C. to 95° C., from 95° C. to 115° C., from 95° C. to 110° C., from 95° C. to 105° C., from 95° C. to 100° C., from 100° C. to 115° C., from 100° C. to 110° C., from 100° C. to 105° C., from 105° C. to 115° C., from 105° C. to 110° C., or from 110° C. to 115° C. In embodiments, the protonated zeolite powder may be heated in the first calcination unit 200 for a time period sufficient to dry any remaining water from the protonated zeolite powder, for example, from 5 hours to 15 hours, from 5 hours to 13 hours, from 5 hours to 11 hours, from 5 hours to 9 hours, from 5 hours to 7 hours, from 7 hours to 15 hours, from 7 hours to 13 hours, from 7 hours to 11 hours, from 7 hours to 9 hours, from 9 hours to 15 hours, from 9 hours to 13 hours, from 9 hours to 11 hours, from 11 hours to 15 hours, from 11 hours to 13 hours, or from 13 hours to 15 hours.

After the protonated zeolite powder has been dried, it may be calcined in the first calcination unit 200 to produce the boron-silicalite-1 zeolite. The first calcination unit 200 may be operated at a calcination temperature from 500° C. to 600° C., from 500° C. to 580° C., from 500° C. to 560° C., from 500° C. to 540° C., from 500° C. to 520° C., from 520° C. to 600° C., from 520° C. to 580° C., from 520° C. to 560° C., from 520° C. to 540° C., from 540° C. to 600° C., from 540° C. to 580° C., from 540° C. to 560° C., from 560° C. to 600° C., from 560° C. to 580° C., or from 590° C. to 600° C. In embodiments, the protonated zeolite powder may be calcined in the first calcination unit 200 for a time period sufficient to calcine the protonated zeolite powder, for example, from 4 hours to 10 hours, from 4 hours to 8 hours, from 4 hours to 6 hours, from 6 hours to 10 hours, from 6 hours to 8 hours, or from 8 hours to 10 hours.

After completing the calcination, the boron-silicalite-1 zeolite may be cooled down to a temperature of from 20° C. to 50° C., from 20° C. to 40° C., from 20° C. to 30° C., from 30° C. to 50° C., from 30° C. to 40° C., or from 40° C. to 50° C.

In embodiments, the boron-silicalite-1 zeolite produced by system 1000 may be a microscale boron-silicalite-1 zeolite. In embodiments, the microscale boron-silicalite-1 zeolite may have an average crystal size of from 1 micrometers (μm) to 5 μm, from 1 μm to 4 μm, from 1 μm to 3 μm, from 1 μm to 2 μm, from 2 μm to 5 μm, from 2 μm to 4 μm, from 2 μm to 3 μm, from 3 μm to 5 μm, from 3μm to 4 μm, or from 4 μm to 5 μm when measured according to

Scanning Electron Microscopy (SEM). SEM images were measured with a JEOL, JSM 5800 scanning microscope at a magnification of 7000. Before taking SEM photographs, the samples were loaded on a sample holder, held with conductive aluminum tape, and coated with a film of gold in a vacuum with a Cressington sputter ion-coater for 20 seconds with 15 milliampere (mA) current. In embodiments, the microscale boron-silicalite zeolite may be used as a catalyst, a catalyst support, or both in refinery, gas separation, and carbon dioxide separation and capture processes.

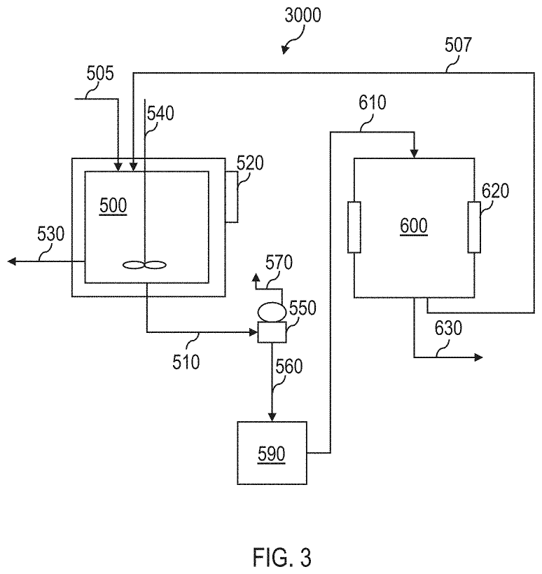

Referring now to FIG. 2, in some embodiments, once the alkali-zeolite has been produced, rather than passing the alkali-zeolite back to the first microwave unit 100, the alkali-zeolite may be evacuated from the calcination unit 200 via a line 230 and passed to a second microwave unit 300 via line 230. FIG. 3 depicts a system 2000 that utilizes multiple microwave irradiation ovens for the production of microscale of boron-silicalite-1. As shown in FIG. 2, the system may include a first microwave unit 100, a first calcination unit 200, a second microwave unit 300, and a second calcination unit 400. In such embodiments, the second microwave unit 300 may provide additional process flexibility because the first microwave unit 100 and the second microwave unit 300 can be designed to have different specifications or process conditions.

Similar to the system of FIG. 1, FIG. 2 depicts a system where, once the alkali-zeolite has been produced, the alkali-zeolite may be evacuated from the calcination unit 200 via a line 230 and passed to the second microwave unit 300 via line 230. The second microwave unit 300 of system 2000 may be utilized to promote faster crystallization.

Subsequently, the ammonium nitrate solution may be introduced into the second microwave unit 300 via line 305. In embodiments, the ammonium nitrate solution may have a molarity of from 1.0 M to 2.0 M, from 1.0 M to 1.8 M, from 1.0 M to 1.6 M, from 1.0 M to 1.4 M, from 1.0 M to 1.2 M, from 1.2 M to 2.0 M, from 1.2 M to 1.8 M, from 1.2 M to 1.6 M, from 1.2 M to 1.4 M, from 1.4 M to 2.0 M, from 1.4 M to 1.8 M, from 1.4 M to 1.6 M, from 1.6 M to 2.0 M, from 1.6 M to 1.8 M, or from 1.8 M to 2.0 M.

To produce an ion-exchanged zeolite solution, the alkali-zeolite and ammonium nitrate solution may be stirred in the second microwave unit 300 via the second stirrer 340 at a speed of from 280 rpm to 320 rpm, from 280 rpm to 310 rpm, from 280 rpm to 300 rpm, from 280 rpm to 290 rpm, from 290 rpm to 320 rpm, from 290 rpm to 310 rpm, from 290 rpm to 300 rpm, from 300 rpm to 320 rpm, from 300 rpm to 310 rpm, or from 310 rpm to 320 rpm. In embodiments, the second microwave unit 300 may be stirred for a time period sufficient to produce the ion-exchanged zeolite solution, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

To produce a protonated zeolite solution, heat may be applied to the second microwave unit 300 via a second microwave irradiation element 320. In embodiments, the second microwave unit 300 may be heated to a protonation temperature of from 65° C. to 90° C., from 65° C. to 85° C., from 65° C. to 80° C., from 65° C. to 75° C., from 65° C. to 70° C., from 70° C. to 85° C., from 70° C. to 80° C., from 70° C. to 75° C., from 75° C. to 85° C., from 75° C. to 80° C., or from 80° C. to 85° C. In embodiments, as heat is applied via the second microwave irradiation element 320, the second microwave unit 300 may be mixed at a protonation stirring speed of from 350 revolutions per minute (rpm) to 400 rpm, from 350 rpm to 390 rpm, from 350 rpm to 380 rpm, from 350 rpm to 370 rpm, from 350 rpm to 360 rpm, from 360 rpm to 400 rpm, from 360 rpm to 390 rpm, from 360 rpm to 380 rpm, from 360 rpm to 370 rpm, from 370 rpm to 400 rpm, from 370 rpm to 390 rpm, from 370 rpm to 380 rpm, from 380 rpm to 400 rpm, from 380 rpm to 390 rpm, or from 390 rpm to 400 rpm. As heat is applied via the second microwave irradiation element 320, the second microwave unit 300 may be operated at the protonation temperature and the protonation stirring speed for a protonation time period of from 5 minutes to 15 minutes, from 5 minutes to 10 minutes, or from 10 minutes to 15 minutes.

Next, the protonated zeolite solution within the second microwave unit 300 may be cooled to a temperature of from 15° C. to 35° C., from 15° C. to 30° C., from 15° C. to 25° C., from 15° C. to 20° C., from 20° C. to 35° C., from 20° C. to 30° C., from 20° C. to 25° C., from 20° C. to 25° C., from 25° C. to 35° C., from 25° C. to 30° C., or from 30° C. to 35° C. Once the protonated zeolite solution has cooled, the solid phase of the protonated zeolite solution comprising the protonated zeolite powder may settle in the solution, and the liquid phase of the protonated zeolite solution (i.e., the washing water without the protonated zeolite powder) may be evacuated through line 330.

In embodiments, the protonated zeolite powder remaining in the second microwave unit 300 may be washed. To wash the protonated zeolite powder, an amount of water sufficient to wash the protonated zeolite powder may be fed into the second microwave unit 300 via line 305. In embodiments, the ratio of the amount of water to the protonated zeolite powder may be in a range of from 1:5 to 1:15, from 1:5 to 1:10, or from 1:10 to 1:15. Once the water has been added, the second microwave unit 300 may be stirred via the second stirrer 340 at a speed of from 100 rpm to 200 rpm, from 100 rpm to 180 rpm, from 100 rpm to 160 rpm, from 100 rpm to 140 rpm, from 100 rpm to 120 rpm, from 120 rpm to 200 rpm, from 120 rpm to 180 rpm, from 120 rpm to 160 rpm, from 120 rpm to 140 rpm, from 140 rpm to 200 rpm, from 140 rpm to 180 rpm, from 140 rpm to 160 rpm, from 160 rpm to 200 rpm, from 160 rpm to 180 rpm, or from 180 rpm to 200 rpm. In embodiments, the second microwave unit 300 may be stirred for a time period sufficient to wash the protonated zeolite powder, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

In embodiments, one or more of the ion-exchange, protonation, and washing steps in the second microwave unit 300 may be repeated. In some embodiments, each step may be repeated consecutively or the entire sequence (for example, one ion-exchange step, one protonation step, and one washing step) may be repeated after one sequence is complete. In embodiments, each step may be repeated 2, 3, or more times. For example, in embodiments, the methods disclosed herein may include an ion-exchange step, a protonation step, and a washing step, then an additional ion-exchange step, an additional protonation step, and an additional washing step.

Once the protonated zeolite powder has been washed, the protonated zeolite powder in solution (comprised of the washing water) may be evacuated via line 310 to a second centrifuge unit 350 to separate the aqueous phase of the solution (comprising the washing water) from the solid phase of the solution (comprising the protonated zeolite powder). Once separated, the solid phase (comprising the protonated zeolite powder) may be evacuated from the second centrifuge unit 350 via line 360, and the aqueous phase (comprising the washing water) may be evacuated from second first centrifuge unit 350 via line 370. In embodiments, the second centrifuge unit 350 may be operated at a speed of from 2500 rpm to 3500 rpm, from 2500 rpm to 3250 rpm, from 2500 rpm to 3000 rpm, from 2500 rpm to 2750 rpm, from 2750 rpm to 3500 rpm, from 2750 rpm to 3250 rpm, from 2750 rpm to 3000 rpm, from 3000 rpm to 3500 rpm, from 3000 rpm to 3250 rpm, or from 3250 rpm to 3500 rpm. In embodiments, the second centrifuge unit 350 may be operated at a flow rate of from 0.05 kg/min to 0.20 kg/min, from 0.05 kg/min to 0.15 kg/min, from 0.05 kg/min to 0.10 kg/min, from 0.10 kg/min to 0.20 kg/min, from 0.10 kg/min to 0.15 kg/min, or from 0.15 kg/min to 0.20 kg/min.

Once evacuated from the second centrifuge unit 350, the solid phase (comprising the protonated zeolite powder) may be passed to the second zeolite powder collector 390 before being passed via line 410 to the second calcination unit 400.

In embodiments, the protonated zeolite powder may be heated in the second calcination unit 400 to dry any remaining water from the protonated zeolite powder. In embodiments, the protonated zeolite powder may be heated in the second calcination unit 400 at a temperature and for a time period sufficient to dry any remaining water from the protonated zeolite powder at a constant temperature. In embodiments, the second heating element 420 may be an electric heater. The second heating element 420 may heat the second calcination unit 400 at a heating rate of from 10° C./minute to 30° C./minute, from 10° C./minute to 25° C./minute, from 10° C./minute to 20° C./minute, from 10° C./minute to 15° C./minute, from 15° C./minute to 30° C./minute, from 15° C./minute to 25° C./minute, from 15° C./minute to 20° C./minute, from 20° C./minute to 30° C./minute, from 20° C./minute to 25° C./minute, or from 25° C./minute to 30° C./minute to reach the drying temperature. The drying temperature may be a temperate of from 90° C. to 115° C., from 90° C. to 110° C., from 90° C. to 105° C., from 90° C. to 100° C., from 90° C. to 95° C., from 95° C. to 115° C., from 95° C. to 110° C., from 95° C. to 105° C., from 95° C. to 100° C., from 100° C. to 115° C., from 100° C. to 110° C., from 100° C. to 105° C., from 105° C. to 115° C., from 105° C. to 110° C., or from 110° C. to 115° C. In embodiments, the protonated zeolite powder may be heated in the second calcination unit 400 for a time period sufficient to dry any remaining water from the protonated zeolite powder, for example, from 5 hours to 15 hours, from 5 hours to 13 hours, from 5 hours to 11 hours, from 5 hours to 9 hours, from 5 hours to 7 hours, from 7 hours to 15 hours, from 7 hours to 13 hours, from 7 hours to 11 hours, from 7 hours to 9 hours, from 9 hours to 15 hours, from 9 hours to 13 hours, from 9 hours to 11 hours, from 11 hours to 15 hours, from 11 hours to 13 hours, or from 13 hours to 15 hours.

After the protonated zeolite powder has been dried, it may be calcined in the second calcination unit 400 to produce the boron-silicalite-1 zeolite. The second calcination unit 400 may be operated at a calcination temperature from 500° C. to 600° C., from 500° C. to 580° C., from 500° C. to 560° C., from 500° C. to 540° C., from 500° C. to 520° C., from 520° C. to 600° C., from 520° C. to 580° C., from 520° C. to 560° C., from 520° C. to 540° C., from 540° C. to 600° C., from 540° C. to 580° C., from 540° C. to 560° C., from 560° C. to 600° C., from 560° C. to 580° C., or from 590° C. to 600° C. In embodiments, the protonated zeolite powder may be calcined in the second calcination unit 400 for a time period sufficient to calcine the protonated zeolite powder, for example, from 4 hours to 10 hours, from 4 hours to 8 hours, from 4 hours to 6 hours, from 6 hours to 10 hours, from 6 hours to 8 hours, or from 8 hours to 10 hours.

After completing the calcination, the boron-silicalite-1 zeolite may be cooled down to a temperature of from 20° C. to 50° C., from 20° C. to 40° C., from 20° C. to 30° C., from 30° C. to 50° C., from 30° C. to 40° C., or from 40° C. to 50° C.

In embodiments, the boron-silicalite-1 zeolite produced by system 2000 may be a microscale boron-silicalite-1 zeolite. In embodiments, the microscale boron-silicalite-1 zeolite may have an average crystal size of from 1 micrometers (μm) to 5 μm, from 1 μm to 4 μm, from 1 μm to 3 μm, from 1 μm to 2 μm, from 2 μm to 5 μm, from 2 μm to 4 μm, from 2 μm to 3 μm, from 3 μm to 5 μm, from 3 μm to 4 μm, or from 4 μm to 5 μm when measured according to Scanning Electron Microscopy (SEM). In embodiments, the microscale boron-silicalite zeolite may be used as a catalyst, a catalyst support, or both in refinery, gas separation, and carbon dioxide separation and capture processes.

In embodiments, the boron-silicalite-1 zeolite produced by system 1000 or system 2000 may be combined with a binder to produce a catalyst system. In embodiments, the catalyst system may include from 20 wt. % to 60 wt. %, from 20 wt. % to 50 wt. %, from 20 wt. % to 40 wt. %, from 20 wt. % to 30 wt. %, from 30 wt. % to 60 wt. %, from 30 wt. % to 50 wt. %, from 30 wt. % to 40 wt. %, from 40 wt. % to 60 wt. %, from 40 wt. % to 50 wt. %, or from 50 wt. % to 60 wt. % boron-silicalite-1. In embodiments, the catalyst system may include from 20 wt. % to 60 wt. %, from 20 wt. % to 50 wt. %, from 20 wt. % to 40 wt. %, from 20 wt. % to 30 wt. %, from 30 wt. % to 60 wt. %, from 30 wt. % to 50 wt. %, from 30 wt. % to 40 wt. %, from 40 wt. % to 60 wt. %, from 40 wt. % to 50 wt. %, or from 50 wt. % to 60 wt. % of an alumina binder. In embodiments, the catalyst system may have a silicon/boron ratio of from 5 to 15, from 5 to 10, or from 10 to 15.

Hydrothermal Systems

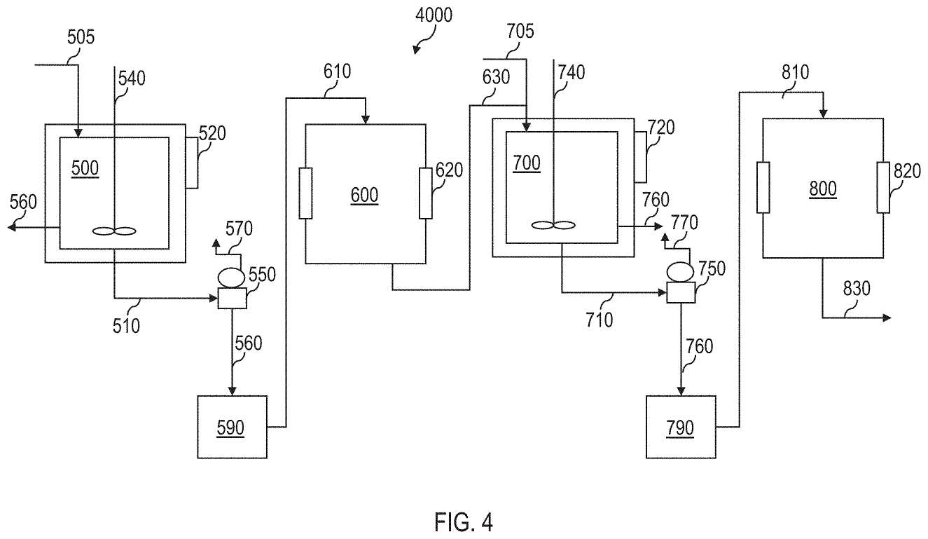

Embodiments of systems for producing boron-silicalite-1 that may include one or more hydrothermal treatment steps and calcination steps will now be described. FIGS. 3 and 4 each depict an embodiment of a system that utilizes one or two hydrothermal oven(s), respectively. In embodiments, the incorporation of the hydrothermal oven may allow for the production of both nanoscale and microscale of boron-silicalite-1. As shown in FIG. 3, the system 3000 for producing boron-silicalite-1 may include a first hydrothermal unit 500 and a first calcination unit 600. As shown in FIG. 4, the system 4000 for producing boron-silicalite-1 may include a first microwave unit 500, a first calcination unit 600, a second microwave unit 700, and a second calcination unit 800. The first hydrothermal unit 500 may be utilized to promote crystallization that allows for microscale boron-silicalte-1 and nanoscale boron-silicalte-1 to be produced. The first hydrothermal unit 500 may also be utilized to promote ion exchange and protonation.

Referring now to FIG. 3, embodiments of the system 3000 include a feed that may enter the first hydrothermal unit 500 via a line 505. The feed, in embodiments, may include one or more of a mineralizer agent, a templating agent, water, and boric acid. In some embodiments, no mineralizer agent may be used. In embodiments, the one or more of the mineralizer agent, the templating agent, the water, and the boric acid may be fed separately to the first hydrothermal unit 500, fed together to the first hydrothermal unit 500, or fed to the first hydrothermal unit 500 in various combinations. In embodiments, the mineralizer agent may be an aqueous metal hydroxide solution. The aqueous metal hydroxide solution may include a single metal hydroxide species, or may be a combination of two or more metal hydroxide chemical species. In embodiments, the aqueous metal hydroxide solution comprises at least one alkali metal hydroxide, at least one alkali earth metal hydroxide, or combinations thereof. The aqueous metal hydroxide solution may comprise lithium hydroxide (LiOH), sodium hydroxide (NaOH), potassium hydroxide (KOH), rubidium hydroxide (RbOH), magnesium hydroxide (Mg(OH)₂), calcium hydroxide (Ca(OH)₂), strontium hydroxide (Sr(OH)₂), barium hydroxide (Ba(OH)₂), or combinations thereof. In some embodiments, the mineralizer agent utilized may include sodium hydroxide, potassium hydroxide, or both. Templating agents may include, by way of non-limiting example, hydrocarbon polymers, nitrogen doped hydrocarbon polymers, tetraethylammonium hydroxide, imethoxsilylpropyldimethyloctadecyl ammonium chloride, tetrapropyl ammonium hydroxide, cetyltrimethylammonium bromide, or combinations thereof. In embodiments, the feed may also include pore-directing agents which may include cationic surfactants and non-ionic surfactants. Cationic surfactant pore-directing agents may include, by way of non-limiting example, dodecyltrimethylammonium, cetyltrimethylammonium, propyltrimethylammonium, tetraethylammonium, tetrapropylammonium, octyltrimethylammonium, or combinations thereof. Non-ionic surfactant pore-directing agents may include, by way of non-limiting example, monoamines, polyamines, or combinations thereof. In embodiments, the feed may further include water. In particular embodiments, the water may be deionized water.

In embodiments, water and the mineralizer agent may be introduced into the hydrothermal unit 500 via the line 505. In some embodiments, to produce nanoscale boron-silicalite-1, no mineralizer agent may be utilized. The water and the mineralizer agent may then be mixed via a stirrer 540 to produce a mineralizer solution. In embodiments, the mineralizer solution may be a homogenous mixture. Thus, the water and the mineralizer agent may be mixed via the stirrer 540 until a homogenous mineralizer solution is produced. In embodiments, the water and the mineralizer agent may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm.

Once the water and the mineralizer agent are sufficiently mixed to produce the mineralizer solution, the templating agent may be introduced into the first hydrothermal unit 500 via the line 505 to be mixed with the mineralizer solution. The templating agent may be utilized to facilitate the formation of the MFI structure within the silicalite-1. Once the templating agent is introduced into the first hydrothermal unit 500, the templating agent and mineralizer solution may be mixed via a first stirrer 540 to produce a synthesis mixture. In embodiments, the templating agent and mineralizer solution may be mixed via the first stirrer 540 until a homogenous synthesis mixture is produced. Without being limited by any particular theory, it is believed that mixing the templating agent and the mineralizer solution may evenly disperse the templating agent within the mineralizer solution to produce the homogenous synthesis mixture. In embodiments, the templating agent and mineralizer solution may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. In embodiments, the templating agent and mineralizer solution may be mixed for a time from 1 minute to 15 minutes, from 1 minute to 10 minutes, from 1 minute to 5 minutes, from 5 minutes to 15 minutes, from 5 minutes to 10 minutes, or from 10 minutes to 15 minutes.

Once the synthesis mixture is produced, a silicon compound may be introduced into the first hydrothermal unit 500 via line 505. In one or more embodiments, the silicon compound may comprise silica, sodium silicate, colloidal silica, fumed silica, or combinations thereof. In one embodiment, the silicon compound comprises colloidal silica. In some embodiments, once the synthesis mixture is produced, colloidal silica may be introduced into the first hydrothermal unit 500 via line 505. The colloidal silica may be from 20 percent by weight (wt. %) to 50 wt. %, from 20 wt. % to 40 wt. %, from 20 wt. % to 30 wt. %, from 30 wt. % to 50 wt. %, from 30 wt. % to 40 wt. %, or from 40 wt. % to 50 wt. % suspension in water based on the total weight of the colloidal silica. Once the silicon compound is introduced into the first hydrothermal unit 500, the silicon compound and synthesis mixture may be mixed via the first stirrer 540 to produce a zeolite solution. In embodiments, the silicon compound and synthesis mixture may be mixed via the first stirrer 540 until a homogenous zeolite solution is produced. In embodiments, the silicon compound and synthesis mixture may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. In embodiments, the silicon compound and synthesis mixture may be mixed for a time from 1 minute to 15 minutes, from 1 minute to 10 minutes, from 1 minute to 5 minutes, from 5 minutes to 15 minutes, from 5 minutes to 10 minutes, or from 10 minutes to 15 minutes.

In embodiments, to produce the nanoscale boron-silicalte-1, tetraethyl orthosilicate may be introduced into the first hydrothermal unit 500 via the line 505 to produce the zeolite solution. The tetraethyl orthosilicate and the synthesis mixture may then be mixed via a first stirrer 40. In embodiments, the tetraethyl orthosilicate and the synthesis mixture may be mixed via the first stirrer 540 until a homogenous mixture is produced. In embodiments, the tetraethyl orthosilicate and the synthesis mixture may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. In embodiments, the tetraethyl orthosilicate and the synthesis mixture may be mixed for a time from 1 minute to 15 minutes, from 1 minute to 10 minutes, from 1 minute to 5 minutes, from 5 minutes to 15 minutes, from 5 minutes to 10 minutes, or from 10 minutes to 15 minutes.

Once the zeolite solution is produced, boric acid may be introduced into the first hydrothermal unit 500 via line 505. The presently-disclosed methods may allow for flexibility with respect to the boron content of the final boron-silicalite-1, which may be adjusting the amount of boric acid added. In embodiments, the boric acid may be added in an amount so that the silicon to boron ratio is from 5 to 5000, from 5 to 1000, from 5 to 500, from 5 to 100, from 5 to 50, or from 5 to 10 in the first hydrothermal unit 500. The boric acid may be added in an amount so that the silicon to boron ratio is 10 in the first hydrothermal unit 500. Once the boric acid is introduced into the first hydrothermal unit 500, the boric acid and zeolite solution may be mixed via the first stirrer 540 to produce a boron-zeolite solution. In embodiments, the boric acid and zeolite solution may be mixed via the stirrer 540 until a homogenous boron-zeolite solution is produced. In embodiments, the boric acid and zeolite solution may be mixed at a stirring speed of from 250 revolutions per minute (rpm) to 350 rpm, from 250 rpm to 325 rpm, from 250 rpm to 300 rpm, from 250 rpm to 275 rpm, from 275 rpm to 350 rpm, from 275 rpm to 325 rpm, from 275 rpm to 300 rpm, from 300 rpm to 350 rpm, from 300 rpm to 325 rpm, or from 325 rpm to 350 rpm. In embodiments, the boric acid and zeolite solution may be mixed for a time sufficient to produce the homogenous mixture, for example, from 30 minutes to 5 hours, from 30 minutes to 4 hours, from 30 minutes to 3 hours, from 30 minutes to 2 hours, from 30 minutes to 1 hour, from 1 hour to 5 hours, from 1 hour to 4 hours, from 1 hour to 3 hours, from 1 hour to 2 hours, from 2 hours to 5 hours, from 2 hours to 4 hours, from 2 hours to 3 hours, from 3 hours to 5 hours, from 3 hours to 4 hours, or from 4 hours to 5 hours. In other embodiments, the boric acid and zeolite solution may be mixed for a time sufficient to produce the homogenous mixture, for example, from 3 hours to 5 hours, from 3 hours to 4 hours, or from 4 hours to 5 hours. [fast and slow aging embodiments]

In embodiments, heat may be applied to the first hydrothermal unit 500 via a first hydrothermal heating element 520 to accelerate crystallization of the boron-silicalite-1. In embodiments, the first hydrothermal unit 500 may be heated to a crystallization temperature of from 100° C. to 200° C., from 100° C. to 180° C., from 100° C. to 160° C., from 100° C. to 140° C., from 100° C. to 120° C., from 120° C. to 200° C., from 120° C. to 180° C., from 120° C. to 160° C., from 120° C. to 140° C., from 140° C. to 200° C., from 140° C. to 180° C., from 140° C. to 160° C., from 160° C. to 200° C., from 160° C. to 180° C., or from 180° C. to 200° C. As heat is applied via the first hydrothermal heating element 520 the first hydrothermal unit 500 may be operated at the crystallization temperature for a crystallization time period of from 10 hours to 60 hours, from 10 hours to 50 hours, from 10 hours to 40 hours, from 10 hours to 30 hours, from 10 hours to 20 hours, from 20 hours to 60 hours, from 20 hours to 50 hours, from 20 hours to 40 hours, from 20 hours to 30 hours, from 30 hours to 60 hours, from 30 hours to 50 hours, from 30 hours to 40 hours, from 40 hours to 60 hours, from 40 hours to 50 hours, or from 50 hours to 60 hours. In embodiments, no stirring may be applied to the first hydrothermal unit 500 during the crystallization time period. In embodiments, to produce the microscale boron-silicalite-1 zeolite, the first hydrothermal unit 500 may be heated to a crystallization temperature of from 165° C. to 185° C., from 165° C. to 180° C., from 165° C. to 175° C., from 165° C. to 170° C., from 170° C. to 185° C., from 170° C. to 180° C., from 170° C. to 175° C., from 175° C. to 185° C., from 175° C. to 180° C., or from 180° C. to 185° C. and operated at the crystallization temperature for a crystallization time period of from 40 hours to 55 hours, from 40 hours to 50 hours, from 40 hours to 45 hours, from 45 hours to 55 hours, from 45 hours to 50 hours, or from 50 hour to 55 hours. In embodiments, to produce nanoscale boron-silicalite-1 zeolite, the first hydrothermal unit 500 may be heated to a crystallization temperature of from 100° C. to 120° C., from 100° C. to 115° C., from 100° C. to 110° C., from 100° C. to 105° C., from 105° C. to 120° C., from 105° C. to 115° C., from 105° C. to 110° C., from 110° C. to 120° C., from 110° C. to 115° C., or from 115° C. to 120° C. and operated at the crystallization temperature for a crystallization time period of from 10 hours to 20 hours, from 10 hours to 15 hours, or from 15 hours to 20 hours

Next, the boron-zeolite solution within the first hydrothermal unit 500 may be cooled to a temperature of from 15° C. to 35° C., from 15° C. to 30° C., from 15° C. to 25° C., from 15° C. to 20° C., from 20° C. to 35° C., from 20° C. to 30° C., from 20° C. to 25° C., from 20° C. to 25° C., from 25° C. to 35° C., from 25° C. to 30° C., or from 30° C. to 35° C. Once the boron-zeolite solution has cooled, zeolite powder may settle in the boron-zeolite solution, and the liquid phase of the solution without the zeolite powder may be evacuated through line 530.

In embodiments, the zeolite powder remaining in the first hydrothermal unit 500 may be washed. To wash the zeolite power, an amount of water sufficient to wash the zeolite may be fed into the first hydrothermal unit 500 via line 505. In embodiments, the amount of water sufficient to wash the zeolite may be in a range of from 50 kg to 200 kg, from 50 kg to 150 kg, from 50 kg to 100 kg, from 100 kg to 200, from 100 kg to 150 kg, or from 150 kg to 200 kg. Once the water has been added, the first hydrothermal unit 500 may be stirred via a stirrer 540 at a speed of from 100 rpm to 200 rpm, from 100 rpm to 180 rpm, from 100 rpm to 160 rpm, from 100 rpm to 140 rpm, from 100 rpm to 120 rpm, from 120 rpm to 200 rpm, from 120 rpm to 180 rpm, from 120 rpm to 160 rpm, from 120 rpm to 140 rpm, from 140 rpm to 200 rpm, from 140 rpm to 180 rpm, from 140 rpm to 160 rpm, from 160 rpm to 200 rpm, from 160 rpm to 180 rpm, or from 180 rpm to 200 rpm. In embodiments, the first hydrothermal unit 500 may be stirred for a time period sufficient to wash the zeolite, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

Once the zeolite powder has been washed, the zeolite powder in solution (comprised of the washing water) may be evacuated via line 510 to a first centrifuge unit 550 to separate the aqueous phase of the solution (comprising the washing water) from the solid phase of the solution (comprising the zeolite powder). Once separated, the solid phase (comprising the zeolite powder) may be evacuated from the first centrifuge unit 550 via line 560, and the aqueous phase (comprising the washing water) may be evacuated from the first centrifuge unit 550 via line 570. In embodiments, the first centrifuge unit 550 may be operated at a speed of from 2500 rpm to 3500 rpm, from 2500 rpm to 3250 rpm, from 2500 rpm to 3000 rpm, from 2500 rpm to 2750 rpm, from 2750 rpm to 3500 rpm, from 2750 rpm to 3250 rpm, from 2750 rpm to 3000 rpm, from 3000 rpm to 3500 rpm, from 3000 rpm to 3250 rpm, or from 3250 rpm to 3500 rpm. In embodiments, the first centrifuge unit 150 may be operated at a flow rate of from 0.05 kg/min to 0.20 kg/min, from 0.05 kg/min to 0.15 kg/min, from 0.05 kg/min to 0.10 kg/min, from 0.10 kg/min to 0.20 kg/min, from 0.10 kg/min to 0.15 kg/min, or from 0.15 kg/min to 0.20 kg/min.

Once evacuated from the first centrifuge unit 550, the solid phase (comprising the zeolite powder) may be passed to a first zeolite powder collector 590 before being passed via line 510 to a first calcination unit 600.

In embodiments, the zeolite powder may be heated in the first calcination unit 600 to dry any remaining water from the zeolite. In embodiments, the zeolite may be heated in the first calcination unit 600 at a temperature and for a time period sufficient to dry any remaining water from the zeolite at a constant temperature. In embodiments, the first calcination unit 620 may be heated via a first heating element 620. In further embodiments, the first heating element 620 may be an electric heater. The first heating element 620 may heat the first calcination unit 600 at a heating rate of from 10° C./minute to 30° C./minute, from 10° C./minute to 25° C./minute, from 10° C./minute to 20° C./minute, from 10° C./minute to 15° C./minute, from 15° C./minute to 30° C./minute, from 15° C./minute to 25° C./minute, from 15° C./minute to 20° C./minute, from 20° C./minute to 30° C./minute, from 20° C./minute to 25° C./minute, or from 25° C./minute to 30° C./minute to reach the drying temperature. The drying temperature may be a temperate of from 90° C. to 120° C., from 90° C. to 110° C., from 90° C. to 100° C., from 100° C. to 120° C., from 100° C. to 110° C., from 110° C. to 120° C. In embodiments, the zeolite may be heated in the first calcination unit 600 for a time period sufficient to dry any remaining water from the zeolite, for example, from 5 hours to 15 hours, from 5 hours to 13 hours, from 5 hours to 11 hours, from 5 hours to 9 hours, from 5 hours to 7 hours, from 7 hours to 15 hours, from 7 hours to 13 hours, from 7 hours to 11 hours, from 7 hours to 9 hours, from 9 hours to 15 hours, from 9 hours to 13 hours, from 9 hours to 11 hours, from 11 hours to 15 hours, from 11 hours to 13 hours, or from 13 hours to 15 hours.

After the zeolite powder has been dried, it may be calcined in the first calcination unit 600 to produce an alkali-zeolite. The first calcination unit 600 may be operated at a calcination temperature from 500° C. to 600° C., from 500° C. to 580° C., from 500° C. to 560° C., from 500° C. to 540° C., from 500° C. to 520° C., from 520° C. to 600° C., from 520° C. to 580° C., from 520° C. to 560° C., from 520° C. to 540° C., from 540° C. to 600° C., from 540° C. to 580° C., from 540° C. to 560° C., from 560° C. to 600° C., from 560° C. to 580° C. or from 590° C. to 600° C. In embodiments, the zeolite powder may be calcined in the first calcination unit 600 for a time period sufficient to calcine the zeolite powder, for example, from 4 hours to 10 hours, from 4 hours to 8 hours, from 4 hours to 6 hours, from 6 hours to 10 hours, from 6 hours to 8 hours, or from 8 hours to 10 hours.

After completing the calcination, the alkali-zeolite may be cooled down to a temperature of from 20° C. to 50° C., from 20° C. to 40° C., from 20° C. to 30° C., from 30° C. to 50° C., from 30° C. to 40° C., or from 40° C. to 50° C.

Once the alkali-zeolite has been produced, in some embodiments, the alkali-zeolite may be evacuated from the first calcination unit 600. In embodiments, the alkali-zeolite may be manually evacuated from the first calcination unit 600 via line 630 and passed back to the first hydrothermal unit 500 via line 505. In other embodiments, the alkali-zeolite may be evacuated from the first calcination unit 600 and passed back to the first hydrothermal unit 500 via a recycle line 507.

Subsequently, an ammonium nitrate solution may be introduced into the first hydrothermal unit 500 via line 505. In embodiments, the ammonium nitrate solution may have a molarity of from 1.0 M to 2.0 M, from 1.0 M to 1.8 M, from 1.0 M to 1.6 M, from 1.0 M to 1.4 M, from 1.0 M to 1.2 M, from 1.2 M to 2.0 M, from 1.2 M to 1.8 M, from 1.2 M to 1.6 M, from 1.2 M to 1.4 M, from 1.4 M to 2.0 M, from 1.4 M to 1.8 M, from 1.4 M to 1.6 M, from 1.6 M to 2.0 M, from 1.6 M to 1.8 M, or from 1.8 M to 2.0 M.

In embodiments, the weight ratio of the alkali-zeolite to ammonium nitrate solution may be from 1:5 to 1:10, from 1:5 to 1:9, from 1:5 to 1:8, from 1:5 to 1:7, from 1:5 to 1:6, from 1:6 to 1:10, from 1:6 to 1:9, from 1:6 to 1:8, from 1:6 to 1:7, from 1:7 to 1:10, from 1:7 to 1:9, from 1:7 to 1:8, from 1:8 to 1:10, from 1:8 to 1:9, or from 1:9 to 1:10.

To produce an ion-exchanged zeolite solution, the alkali-zeolite and ammonium nitrate solution may be stirred in the first hydrothermal unit 500 via the first stirrer 540 at a speed of from 280 rpm to 320 rpm, from 280 rpm to 310 rpm, from 280 rpm to 300 rpm, from 280 rpm to 290 rpm, from 290 rpm to 320 rpm, from 290 rpm to 310 rpm, from 290 rpm to 300 rpm, from 300 rpm to 320 rpm, from 300 rpm to 310 rpm, or from 310 rpm to 320 rpm. In embodiments, the first microwave unit 100 may be stirred for a time period sufficient to produce the ion-exchanged zeolite solution, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

To produce a protonated zeolite solution, heat may be applied to the first hydrothermal unit 500 via the first hydrothermal heating element 520. In embodiments, the first hydrothermal unit 500 may be heated to a protonation temperature of from 65° C. to 90° C., from 65° C. to 85° C., from 65° C. to 80° C., from 65° C. to 75° C., from 65° C. to 70° C., from 70° C. to 85° C., from 70° C. to 80° C., from 70° C. to 75° C., from 75° C. to 85° C., from 75° C. to 80° C., or from 80° C. to 85° C. In embodiments, as heat is applied via the first hydrothermal heating element 520, the first hydrothermal unit 500 may be mixed at a protonation stirring speed of from 350 revolutions per minute (rpm) to 400 rpm, from 350 rpm to 390 rpm, from 350 rpm to 380 rpm, from 350 rpm to 370 rpm, from 350 rpm to 360 rpm, from 360 rpm to 400 rpm, from 360 rpm to 390 rpm, from 360 rpm to 380 rpm, from 360 rpm to 370 rpm, from 370 rpm to 400 rpm, from 370 rpm to 390 rpm, from 370 rpm to 380 rpm, from 380 rpm to 400 rpm, from 380 rpm to 390 rpm, or from 390 rpm to 400 rpm. As heat is applied via the first hydrothermal heating element 520 the first hydrothermal unit 500 may be operated at the protonation temperature and the protonation stirring speed for a protonation time period of from 5 minutes to 15 minutes, from 5 minutes to 10 minutes, or from 10 minutes to 15 minutes.

Next, the protonated zeolite solution within the first hydrothermal unit 500 may be cooled to a temperature of from 15° C. to 35° C., from 15° C. to 30° C., from 15° C. to 25° C., from 15° C. to 20° C., from 20° C. to 35° C., from 20° C. to 30° C., from 20° C. to 25° C., from 20° C. to 25° C., from 25° C. to 35° C., from 25° C. to 30° C., or from 30° C. to 35° C. Once the protonated zeolite solution has cooled, the solid phase of the protonated zeolite solution comprising the protonated zeolite powder may settle in the solution, and the liquid phase of the protonated zeolite solution (i.e. the washing water without the protonated zeolite powder) may be evacuated through line 530.

In embodiments, the protonated zeolite powder remaining in the first hydrothermal unit 500 may be washed. To wash the protonated zeolite powder, an amount of water sufficient to wash the protonated zeolite powder may be fed into the first hydrothermal unit 500 via line 505. In embodiments, the ratio of the amount of water to the protonated zeolite powder may be in a range of from 1:5 to 1:15, from 1:5 to 1:10, or from 1:10 to 1:15. Once the water has been added, the first hydrothermal unit 500 may be stirred via the first stirrer 540 at a speed of from 100 rpm to 200 rpm, from 100 rpm to 180 rpm, from 100 rpm to 160 rpm, from 100 rpm to 140 rpm, from 100 rpm to 120 rpm, from 120 rpm to 200 rpm, from 120 rpm to 180 rpm, from 120 rpm to 160 rpm, from 120 rpm to 140 rpm, from 140 rpm to 200 rpm, from 140 rpm to 180 rpm, from 140 rpm to 160 rpm, from 160 rpm to 200 rpm, from 160 rpm to 180 rpm, or from 180 rpm to 200 rpm. In embodiments, the first hydrothermal unit 500 may be stirred for a time period sufficient to wash the protonated zeolite powder, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

In embodiments, one or more of the ion-exchange, protonation, and washing steps may be repeated. In some embodiments, each step may be repeated consecutively or the entire sequence (for example one ion-exchange step, one protonation step, and one washing step) may be repeated after one sequence is complete. In embodiments, each step may be repeated 2, 3, or more times. For example, in embodiments, the methods disclosed herein may include an ion-exchange step, a protonation step, and a washing step, then an additional ion-exchange step, an additional protonation step, and an additional washing step.

Once the protonated zeolite powder has been washed, the protonated zeolite powder in solution (comprised of the washing water) may be evacuated via line 510 to the first centrifuge unit 550 to separate the aqueous phase of the solution (comprising the washing water) from the solid phase of the solution (comprising the protonated zeolite powder). Once separated, the solid phase (comprising the protonated zeolite powder) may be evacuated from the first centrifuge unit 550 via line 560, and the aqueous phase (comprising the washing water) may be evacuated from the first centrifuge unit 550 via line 570. In embodiments, the first centrifuge unit 550 may be operated at a speed of from 2500 rpm to 3500 rpm, from 2500 rpm to 3250 rpm, from 2500 rpm to 3000 rpm, from 2500 rpm to 2750 rpm, from 2750 rpm to 3500 rpm, from 2750 rpm to 3250 rpm, from 2750 rpm to 3000 rpm, from 3000 rpm to 3500 rpm, from 3000 rpm to 3250 rpm, or from 3250 rpm to 3500 rpm. In embodiments, the first centrifuge unit 550 may be operated at a flow rate of from 0.05 kg/min to 0.20 kg/min, from 0.05 kg/min to 0.15 kg/min, from 0.05 kg/min to 0.10 kg/min, from 0.10 kg/min to 0.20 kg/min, from 0.10 kg/min to 0.15 kg/min, or from 0.15 kg/min to 0.20 kg/min.

Once evacuated from the first centrifuge unit 550, the solid phase (comprising the protonated zeolite powder) may be passed to the first zeolite powder collector 590 before being passed via line 610 to the first calcination unit 600.

In embodiments, the protonated zeolite powder may be heated in the first calcination unit 600 to dry any remaining water from the protonated zeolite powder. In embodiments, the protonated zeolite powder may be heated in the first calcination unit 600 at a temperature and for a time period sufficient to dry any remaining water from the protonated zeolite powder at a constant temperature. In embodiments, the first heating element 620 may be an electric heater. The first heating element 620 may heat the first calcination unit 600 at a heating rate of from 10° C./minute to 30° C./minute, from 10° C./minute to 25° C./minute, from 10° C./minute to 20° C./minute, from 10° C./minute to 15° C./minute, from 15° C./minute to 30° C./minute, from 15° C./minute to 25° C./minute, from 15° C./minute to 20° C./minute, from 20° C./minute to 30° C./minute, from 20° C./minute to 25° C./minute, or from 25° C./minute to 30° C./minute to reach the drying temperature. The drying temperature may be a temperate of from 90° C. to 115° C., from 90° C. to 110° C., from 90° C. to 105° C., from 90° C. to 100° C., from 90° C. to 95° C., from 95° C. to 115° C., from 95° C. to 110° C., from 95° C. to 105° C., from 95° C. to 100° C., from 100° C. to 115° C., from 100° C. to 110° C., from 100° C. to 105° C., from 105° C. to 115° C., from 105° C. to 110° C., or from 110° C. to 115° C. In embodiments, the protonated zeolite powder may be heated in the first calcination unit 600 for a time period sufficient to dry any remaining water from the protonated zeolite powder, for example, from 5 hours to 15 hours, from 5 hours to 13 hours, from 5 hours to 11 hours, from 5 hours to 9 hours, from 5 hours to 7 hours, from 7 hours to 15 hours, from 7 hours to 13 hours, from 7 hours to 11 hours, from 7 hours to 9 hours, from 9 hours to 15 hours, from 9 hours to 13 hours, from 9 hours to 11 hours, from 11 hours to 15 hours, from 11 hours to 13 hours, or from 13 hours to 15 hours.

After the protonated zeolite powder has been dried, it may be calcined in the first calcination unit 600 to produce the boron-silicalite-1 zeolite. The first calcination unit 600 may be operated at a calcination temperature from 500° C. to 600° C., from 500° C. to 580° C., from 500° C. to 560° C., from 500° C. to 540° C., from 500° C. to 520° C., from 520° C. to 600° C., from 520° C. to 580° C., from 520° C. to 560° C., from 520° C. to 540° C., from 540° C. to 600° C., from 540° C. to 580° C., from 540° C. to 560° C., from 560° C. to 600° C., from 560° C. to 580° C., or from 590° C. to 600° C. In embodiments, the protonated zeolite powder may be calcined in the first calcination unit 600 for a time period sufficient to calcine the protonated zeolite powder, for example, from 4 hours to 10 hours, from 4 hours to 8 hours, from 4 hours to 6 hours, from 6 hours to 10 hours, from 6 hours to 8 hours, or from 8 hours to 10 hours.

After completing the calcination, the boron-silicalite-1 zeolite may be cooled down to a temperature of from 20° C. to 50° C., from 20° C. to 40° C., from 20° C. to 30° C., from 30° C. to 50° C., from 30° C. to 40° C., or from 40° C. to 50° C.

In embodiments, the boron-silicalite-1 zeolite produced by system 3000 may be a microscale boron-silicalite-1 zeolite. In embodiments, the microscale boron-silicalite-1 zeolite may have an average crystal size of from 1 micrometers (μm) to 5 μm, from 1 μm to 4 μm, from 1 μm to 3 μm, from 1 μm to 2 μm, from 2 μm to 5 μm, from 2 μm to 4 μm, from 2 μm to 3 μm, from 3 μm to 5 μm, from 3 μm to 4 μm, or from 4 μm to 5 μm when measured according to Scanning Electron Microscopy (SEM). In embodiments, the boron-silicalite-1 zeolite produced by system 3000 may be a nanoscale boron-silicalite-1 zeolite. In embodiments, the nanoscale boron-silicalite-1 zeolite may have an average crystal size of from 200 nanometers (nm) to 400 nm, from 200 nm to 375 nm, from 200 nm to 350 nm, from 200 nm to 325 nm, from 200 nm to 300 nm, from 200 nm to 275 nm, from 200 nm to 250 nm, from 200 nm to 225 nm, from 225 nm to 400 nm, from 225 nm to 375 nm, from 225 nm to 350 nm, from 225 nm to 325 nm, from 225 nm to 300 nm, from 225 nm to 275 nm, from 225 nm to 250 nm, from 250 nm to 400 nm, from 250 nm to 375 nm, from 250 nm to 350 nm, from 250 nm to 325 nm, from 250 nm to 300 nm, from 250 nm to 275 nm, from 275 nm to 400 nm, from 275 nm to 375 nm, from 275 nm to 350 nm, from 275 nm to 325 nm, from 275 nm to 300 nm, from 300 nm to 400 nm, from 300 nm to 375 nm, from 300 nm to 350 nm, from 300 nm to 325 nm, from 325 nm to 400 nm, from 325 nm to 375 nm, from 325 nm to 350 nm, from 350 nm to 400 nm, from 350 nm to 375 nm, or from 375 nm to 400 nm when measured according to Scanning Electron Microscopy (SEM). In embodiments, the nanoscale boron-silicalite zeolite, the microscale boron-silicalite zeolite, or both may be used as a catalyst, a catalyst support, or both in refinery, gas separation, and carbon dioxide separation and capture processes.

Referring now to FIG. 4, in some embodiments, once the alkali-zeolite has been produced, rather than recycling or manually transferring the alkali-zeolite back to the first hydrothermal unit 500, the alkali-zeolite may be evacuated from the first calcination unit 600 via a line 630 and passed to a second hydrothermal unit 700 via line 630. FIG. 4 depicts a system 4000 that utilizes multiple hydrothermal ovens. In embodiments, the incorporation of the multiple hydrothermal ovens may allow for the production of microscale of boron-silicalite-1. As shown in FIG. 4, the system 4000 may include a first hydrothermal unit 500, a first calcination unit 600, a second hydrothermal unit 700, and a second calcination unit 800. In such embodiments, the second hydrothermal unit 700 may provide additional process flexibility because the first hydrothermal unit 500 and the second hydrothermal unit 700 can be designed to have different specifications or process conditions.

Subsequently, an ammonium nitrate solution may be introduced into the second hydrothermal unit 700 via line 705. In embodiments, the ammonium nitrate solution may have a molarity of from 1.0 M to 2.0 M, from 1.0 M to 1.8 M, from 1.0 M to 1.6 M, from 1.0 M to 1.4 M, from 1.0 M to 1.2 M, from 1.2 M to 2.0 M, from 1.2 M to 1.8 M, from 1.2 M to 1.6 M, from 1.2 M to 1.4 M, from 1.4 M to 2.0 M, from 1.4 M to 1.8 M, from 1.4 M to 1.6 M, from 1.6 M to 2.0 M, from 1.6 M to 1.8 M, or from 1.8 M to 2.0 M.

In embodiments, the weight ratio of the alkali-zeolite to ammonium nitrate solution may be from 1:5 to 1:10, from 1:5 to 1:9, from 1:5 to 1:8, from 1:5 to 1:7, from 1:5 to 1:6, from 1:6 to 1:10, from 1:6 to 1:9, from 1:6 to 1:8, from 1:6 to 1:7, from 1:7 to 1:10, from 1:7 to 1:9, from 1:7 to 1:8, from 1:8 to 1:10, from 1:8 to 1:9, or from 1:9 to 1:10.

Once the alkali-zeolite and ammonium nitrate solution have been added to the second hydrothermal unit 700, the second hydrothermal unit 700 may be stirred via a second stirrer 740 at a speed of from 280 rpm to 320 rpm, from 280 rpm to 310 rpm, from 280 rpm to 300 rpm, from 280 rpm to 290 rpm, from 290 rpm to 320 rpm, from 290 rpm to 310 rpm, from 290 rpm to 300 rpm, from 300 rpm to 320 rpm, from 300 rpm to 310 rpm, or from 310 rpm to 320 rpm. In embodiments, the second hydrothermal unit 700 may be stirred for a time period sufficient to wash the alkali-zeolite, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

In embodiments, to protonate the ion-exchanged zeolite heat may be applied to the second hydrothermal unit 700 via the second hydrothermal heating element 720 to produce a protonated zeolite. In embodiments, the second hydrothermal unit 700 may be heated to an ion exchange temperature of from 65° C. to 90° C., from 65° C. to 85° C., from 65° C. to 80° C., from 65° C. to 75° C., from 65° C. to 70° C., from 70° C. to 85° C., from 70° C. to 80° C., from 70° C. to 75° C., from 75° C. to 85° C., from 75° C. to 80° C., or from 80° C. to 85° C. In embodiments, as heat is applied via the second hydrothermal heating element 720, the second hydrothermal unit 700 may be mixed at a ion exchange stirring speed of from 350 revolutions per minute (rpm) to 400 rpm, from 350 rpm to 390 rpm, from 350 rpm to 380 rpm, from 350 rpm to 370 rpm, from 350 rpm to 360 rpm, from 360 rpm to 400 rpm, from 360 rpm to 390 rpm, from 360 rpm to 380 rpm, from 360 rpm to 370 rpm, from 370 rpm to 400 rpm, from 370 rpm to 390 rpm, from 370 rpm to 380 rpm, from 380 rpm to 400 rpm, from 380 rpm to 390 rpm, or from 390 rpm to 400 rpm. As heat is applied via the second hydrothermal heating element 720 the second hydrothermal unit 700 may be operated at the ion exchange temperature and the ion exchange stirring speed for a crystallization time period of from 100 minutes to 200 minutes, from 100 minutes to 175 minutes, from 100 minutes to 150 minutes, from 100 minutes to 125 minutes, from 125 minutes to 200 minutes, from 125 minutes to 175 minutes, from 125 minutes to 150 minutes, from 150 minutes to 200 minutes, from 150 minutes to 175 minutes, or from 175 minutes to 200 minutes.

Next, the protonated zeolite solution within the second hydrothermal unit 700 may be cooled to a temperature of from 15° C. to 35° C., from 15° C. to 30° C., from 15° C. to 25° C., from 15° C. to 20° C., from 20° C. to 35° C., from 20° C. to 30° C., from 20° C. to 25° C., from 20° C. to 25° C., from 25° C. to 35° C., from 25° C. to 30° C., or from 30° C. to 35° C. Once the protonated zeolite solution has cooled, the solid phase of the protonated zeolite solution comprising the protonated zeolite powder may settle in the solution, and the liquid phase of the protonated zeolite solution (i.e. the washing water without the protonated zeolite powder) may be evacuated through line 730.

In embodiments, the protonated zeolite powder remaining in the second hydrothermal unit 700 may be washed. To wash the protonated zeolite powder, an amount of water sufficient to wash the protonated zeolite powder may be fed into the second hydrothermal unit 700 via line 705. In embodiments, the ratio of the amount of water to the protonated zeolite powder may be in a range of from 1:5 to 1:15, from 1:5 to 1:10, or from 1:10 to 1:15. Once the water has been added, the second hydrothermal unit 700 may be stirred via the second stirrer 740 at a speed of from 100 rpm to 200 rpm, from 100 rpm to 180 rpm, from 100 rpm to 160 rpm, from 100 rpm to 140 rpm, from 100 rpm to 120 rpm, from 120 rpm to 200 rpm, from 120 rpm to 180 rpm, from 120 rpm to 160 rpm, from 120 rpm to 140 rpm, from 140 rpm to 200 rpm, from 140 rpm to 180 rpm, from 140 rpm to 160 rpm, from 160 rpm to 200 rpm, from 160 rpm to 180 rpm, or from 180 rpm to 200 rpm. In embodiments, the second hydrothermal unit 700 may be stirred for a time period sufficient to wash the protonated zeolite powder, for example, for a time period from 1 minute to 10 minutes, from 1 minute to 8 minutes, from 1 minute to 6 minutes, from 1 minute to 4 minutes, from 1 minute to 2 minutes, from 2 minutes to 10 minutes, from 2 minutes to 8 minutes, from 2 minutes to 6 minutes, from 2 minutes to 4 minutes, 4 minutes to 10 minutes, from 4 minutes to 8 minutes, from 4 minutes to 6 minutes, from 6 minutes to 10 minutes, from 6 minutes to 8 minutes, or from 8 minutes to 10 minutes.

In embodiments, one or more of the ion-exchange, protonation, and washing steps may be repeated. In some embodiments, each step may be repeated consecutively or the entire sequence (for example one ion-exchange step, one protonation step, and one washing step) may be repeated after one sequence is complete. In embodiments, each step may be repeated 2, 3, or more times. For example, in embodiments, the methods disclosed herein may include an ion-exchange step, a protonation step, and a washing step, then an additional ion-exchange step, an additional protonation step, and an additional washing step.

Once the protonated zeolite powder has been washed, the protonated zeolite powder in solution (comprised of the washing water) may be evacuated via line 710 to the second centrifuge unit 750 to separate the aqueous phase of the solution (comprising the washing water) from the solid phase of the solution (comprising the protonated zeolite powder). Once separated, the solid phase (comprising the protonated zeolite powder) may be evacuated from the second centrifuge unit 750 via line 760, and the aqueous phase (comprising the washing water) may be evacuated from the second centrifuge unit 750 via line 770. In embodiments, the second centrifuge unit 750 may be operated at a speed of from 2500 rpm to 3500 rpm, from 2500 rpm to 3250 rpm, from 2500 rpm to 3000 rpm, from 2500 rpm to 2750 rpm, from 2750 rpm to 3500 rpm, from 2750 rpm to 3250 rpm, from 2750 rpm to 3000 rpm, from 3000 rpm to 3500 rpm, from 3000 rpm to 3250 rpm, or from 3250 rpm to 3500 rpm. In embodiments, the second centrifuge unit 750 may be operated at a flow rate of from 0.05 kg/min to 0.20 kg/min, from 0.05 kg/min to 0.15 kg/min, from 0.05 kg/min to 0.10 kg/min, from 0.10 kg/min to 0.20 kg/min, from 0.10 kg/min to 0.15 kg/min, or from 0.15 kg/min to 0.20 kg/min.

Once evacuated from the second centrifuge unit 750, the solid phase (comprising the protonated zeolite powder) may be passed to the second zeolite powder collector 790 before being passed via line 810 to the second calcination unit 800.

In embodiments, the protonated zeolite powder may be heated in the second calcination unit 800 to dry any remaining water from the protonated zeolite powder. In embodiments, the protonated zeolite powder may be heated in the second calcination unit 800 at a temperature and for a time period sufficient to dry any remaining water from the protonated zeolite powder at a constant temperature. In embodiments, the second heating element 820 may be an electric heater. The second heating element 820 may heat the second calcination unit 800 at a heating rate of from 10° C./minute to 30° C./minute, from 10° C./minute to 25° C./minute, from 10° C./minute to 20° C./minute, from 10° C./minute to 15° C./minute, from 15° C./minute to 30° C./minute, from 15° C./minute to 25° C./minute, from 15° C./minute to 20° C./minute, from 20° C./minute to 30° C./minute, from 20° C./minute to 25° C./minute, or from 25° C./minute to 30° C./minute to reach the drying temperature. The drying temperature may be a temperate of from 90° C. to 115° C., from 90° C. to 110° C., from 90° C. to 105° C., from 90° C. to 100° C., from 90° C. to 95° C., from 95° C. to 115° C., from 95° C. to 110° C., from 95° C. to 105° C., from 95° C. to 100° C., from 100° C. to 115° C., from 100° C. to 110° C., from 100° C. to 105° C., from 105° C. to 115° C., from 105° C. to 110° C., or from 110° C. to 115° C. In embodiments, the protonated zeolite powder may be heated in the second calcination unit 800 for a time period sufficient to dry any remaining water from the protonated zeolite powder, for example, from 5 hours to 15 hours, from 5 hours to 13 hours, from 5 hours to 11 hours, from 5 hours to 9 hours, from 5 hours to 7 hours, from 7 hours to 15 hours, from 7 hours to 13 hours, from 7 hours to 11 hours, from 7 hours to 9 hours, from 9 hours to 15 hours, from 9 hours to 13 hours, from 9 hours to 11 hours, from 11 hours to 15 hours, from 11 hours to 13 hours, or from 13 hours to 15 hours.

After the protonated zeolite powder has been dried, it may be calcined in the second calcination unit 800 to produce the boron-silicalite-1 zeolite. The second calcination unit 800 may be operated at a calcination temperature from 500° C. to 600° C., from 500° C. to 580° C., from 500° C. to 560° C., from 500° C. to 540° C., from 500° C. to 520° C., from 520° C. to 600° C., from 520° C. to 580° C., from 520° C. to 560° C., from 520° C. to 540° C., from 540° C. to 600° C., from 540° C. to 580° C., from 540° C. to 560° C., from 560° C. to 600° C., from 560° C. to 580° C., or from 590° C. to 600° C. In embodiments, the protonated zeolite powder may be calcined in the second calcination unit 800 for a time period sufficient to calcine the protonated zeolite powder, for example, from 4 hours to 10 hours, from 4 hours to 8 hours, from 4 hours to 6 hours, from 6 hours to 10 hours, from 6 hours to 8 hours, or from 8 hours to 10 hours.

After completing the calcination, the boron-silicalite-1 zeolite may be cooled down to a temperature of from 20° C. to 50° C., from 20° C. to 40° C., from 20° C. to 30° C., from 30° C. to 50° C., from 30° C. to 40° C., or from 40° C. to 50° C.

In embodiments, the boron-silicalite-1 zeolite produced by system 4000 may be a microscale boron-silicalite-1 zeolite. In embodiments, the microscale boron-silicalite-1 zeolite may have an average crystal size of from 1 micrometers (μm) to 5 μm, from 1 μm to 4 μm, from 1 μm to 3 μm, from 1 μm to 2 μm, from 2 μm to 5 μm, from 2 μm to 4 μm, from 2 μm to 3 μm, from 3 μm to 5 μm, from 3 μm to 4 μm, or from 4 μm to 5 μm when measured according to Scanning Electron Microscopy (SEM). In embodiments, the boron-silicalite-1 zeolite produced by system 4000 may be a nanoscale boron-silicalite-1 zeolite. In embodiments, the nanoscale boron-silicalite-1 zeolite may have an average crystal size of from 200 nanometers (nm) to 400 nm, from 200 nm to 375 nm, from 200 nm to 350 nm, from 200 nm to 325 nm, from 200 nm to 300 nm, from 200 nm to 275 nm, from 200 nm to 250 nm, from 200 nm to 225 nm, from 225 nm to 400 nm, from 225 nm to 375 nm, from 225 nm to 350 nm, from 225 nm to 325 nm, from 225 nm to 300 nm, from 225 nm to 275 nm, from 225 nm to 250 nm, from 250 nm to 400 nm, from 250 nm to 375 nm, from 250 nm to 350 nm, from 250 nm to 325 nm, from 250 nm to 300 nm, from 250 nm to 275 nm, from 275 nm to 400 nm, from 275 nm to 375 nm, from 275 nm to 350 nm, from 275 nm to 325 nm, from 275 nm to 300 nm, from 300 nm to 400 nm, from 300 nm to 375 nm, from 300 nm to 350 nm, from 300 nm to 325 nm, from 325 nm to 400 nm, from 325 nm to 375 nm, from 325 nm to 350 nm, from 350 nm to 400 nm, from 350 nm to 375 nm, or from 375 nm to 400 nm when measured according to Scanning Electron Microscopy (SEM). In embodiments, the nanoscale boron-silicalite zeolite, the microscale boron-silicalite zeolite, or both may be used as a catalyst, a catalyst support, or both in refinery, gas separation, and carbon dioxide separation and capture processes.

In embodiments, the boron-silicalite-1 zeolite produced by system 3000 or system 4000 may be combined with a binder to produce a catalyst system. In embodiments, the catalyst system may include from 20 wt. % to 60 wt. %, from 20 wt. % to 50 wt. %, from 20 wt. % to 40 wt. %, from 20 wt. % to 30 wt. %, from 30 wt. % to 60 wt. %, from 30 wt. % to 50 wt. %, from 30 wt. % to 40 wt. %, from 40 wt. % to 60 wt. %, from 40 wt. % to 50 wt. %, or from 50 wt. % to 60 wt. % boron-silicalite-1. In embodiments, the catalyst system may include from 20 wt. % to 60 wt. %, from 20 wt. % to 50 wt. %, from 20 wt. % to 40 wt. %, from 20 wt. % to 30 wt. %, from 30 wt. % to 60 wt. %, from 30 wt. % to 50 wt. %, from 30 wt. % to 40 wt. %, from 40 wt. % to 60 wt. %, from 40 wt. % to 50 wt. %, or from 50 wt. % to 60 wt. % of an alumina binder. In embodiments, the catalyst system may have a silicon/boron ratio of from 5 to 15, from 5 to 10, or from 10 to 15.

### EXAMPLES

The following examples illustrate one or more additional features of the present disclosure. It should be understood that these examples are not intended to limit the scope of the disclosure or the appended claims in any manner.

### Example 1: Microscale Boron-Silicalite-1

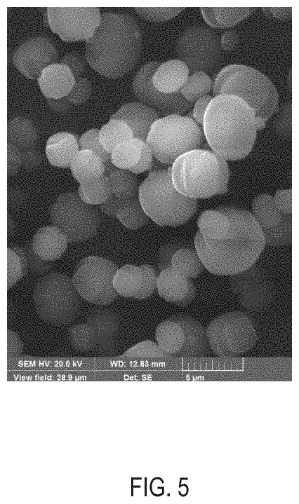

In Example 1, a microscale boron-silicalite-1, shown in FIG. 5, was produced by a hydrothermal system as described herein. To produce the sample depicted in FIG. 5, 77.7 kg of deionized water was poured in a hydrothermal container sealed by PTFE. Then, 0.692 kg of sodium hydroxide was added to the deionized water and continuously stirred at a stirring speed of from 300 rpm until a homogenous mixture was produced. Then, 20.84 kg of tetrapropylammonium hydroxide (TPAOH, 1 molar in water) was added and continuously aged for a period of 10 minutes with stirring speed of 300 rpm. Then, 26 kg of colloidal silica was added and stirred for a time period of 10 minutes at a stirring speed of 300 rpm. Finally, 1.08 kg of boric acid was added and stirred at a stirring speed of 300 rpm for a period of 2 hours until a homogenous solution was produced. The solution was hydrothermally heated to a temperature of from 180° C. without stirring, for a crystallization time period of 15 hours.

Next, the boron-zeolite solution was cooled down to a temperature of 25° C. and zeolite powder settled in the boron-zeolite solution. The liquid phase of the boron-zeolite solution without the zeolite powder was evacuated. Then 100 kg of deionized water for zeolite washing was added and stirring was applied at a speed of 200 rpm for 5 minutes. The solution comprising the washing water and zeolite powder are evacuated to a centrifuge unit to separate the light phase (washing water) and heavy phase (zeolite powder) at a centrifuge speed of from 2500 rpm and a flow rate of 0.1 kg/min. The light phase (washing water) was purged from the system, and the heavy phase containing mainly zeolite powder was evacuated to a zeolite powder collector before being transferred to a calcination unit. At the calcination unit, any remaining water was dried from the zeolite powder by drying the zeolite powder. To dry the zeolite powder, the zeolite powder was heated at a heating rate of 15° C./min using an electrical heater to a temperature of 100° C. and kept held at that temperature for a time period of 10 hours. Then, to form an alkali-zeolite, the zeolite powder was calcined at a temperature of 550° C. and kept held at that temperature for a period of 6 hours. Then, the alkali-zeolite was cooled down to a temperature of 25° C.

After the alkali-zeolite was calcined and cooled down, the alkali-zeolite was evacuated manually and sent to a second hydrothermal unit. Then, to perform an ion-exchange step, a pre-prepared of ammonium nitrate solution (1-2 molar) was introduced into the second hydrothermal unit. The ratio of alkali-zeolite to ammonium nitrate solution was maintained to be 1:10. The alkali-zeolite and ammonium nitrate solution was aged vigorously at a stirring speed of 300 rpm to produce an ion-exchanged zeolite. To protonate the ion-exchanged zeolite, the ion-exchanged zeolite was heated via a hydrothermal oven at a temperature of 80° C., for a time of 120 minutes, and at a stirring speed of 400 rpm. After the ion exchange and protonation steps were completed, the protonated zeolite powder was allowed to settle, and the liquid (without the protonated zeolite powder) was separated from purged from the system. Deionized water was used to wash the protonated zeolite powder by using ratio of protonated zeolite to water of 1:10 and aged vigorously, then the washing water was evacuated after the protonated zeolite powder settled. Finally, the protonated zeolite powder was concentrated and sent to a second calcination unit for drying and calcination.

To dry the protonated zeolite powder, the protonated zeolite powder heated via an electrical heater at a heating ramp rate of 15° C./min to a temperature of 100° C. and held at that temperature for 10 hours. Then, to form the final boron-silicalite-1 sample, the protonated zeolite powder was calcined at a temperature of 550° C. and kept held at that temperature for a period of 5 hours. Then, the alkali-zeolite was cooled down to a temperature of 25° C.

### Example 2: Nanoscale Boron-Silicalite-1

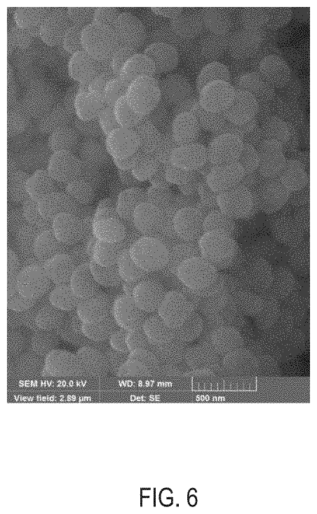

In Example 2, a nanoscale boron-silicalite-1, shown in FIG. 6, was produced by a hydrothermal system as described herein. To produce the sample depicted in FIG. 6, 74.68 kg of deionized water was poured in a hydrothermal container sealed by PTFE. No mineralizer agent of sodium hydroxide or potassium hydroxide was used. After that, 31.92 kg of tetrapropylammonium hydroxide (TPAOH, 1 molar in water) was added and was continuously aged for a period of from 5 minutes to 10 minutes with stirring speed of 300 rpm. Then 20 kg of tetraethyl orthosilicate was added and stirred for a time period of from 5 minutes to 10 minutes at a stirring speed of 300 rpm. Finally, 0.6 kg of boric acid was added and stirred for 8 hours with stirring speed of 300 rpm until a homogenous solution was produced. The solution was hydrothermally heated to a temperature of from 100° C. without stirring, for a crystallization time period of 15 hours.

Next, the boron-zeolite solution was cooled down to a temperature of 30° C. and zeolite powder settled in the boron-zeolite solution. The liquid phase of the boron-zeolite solution without the zeolite powder was evacuated. Then 100 kg of deionized water for zeolite washing was added and stirring was applied at a speed of 150 rpm for 5 minutes. The solution comprising the washing water and zeolite powder are evacuated to a centrifuge unit to separate the light phase (washing water) and heavy phase (zeolite powder) at a centrifuge speed of 3000 rpm and a flow rate of 0.1 kg/min. The light phase (washing water) was purged from the system, and the heavy phase containing mainly zeolite powder was evacuated to a zeolite powder collector before being transferred to a calcination unit. At the calcination unit, any remaining water was dried from the zeolite powder by drying the zeolite powder. To dry the zeolite powder, the zeolite powder was heated at a heating rate of 15° C./min using an electrical heater to a temperature of 100° C. and kept held at that temperature for a time period of 10 hours. Then, to form an alkali-zeolite, the zeolite powder was calcined at a temperature of from 550° C. and kept held at that temperature for a period of 6 hours. Then, the alkali-zeolite was cooled down to a temperature of 25° C.

After the alkali-zeolite was calcined and cooled down, the alkali-zeolite was evacuated manually and sent to a second hydrothermal unit. Then, to perform an ion-exchange step, a pre-prepared of ammonium nitrate solution (1-2 molar) was introduced into the hydrothermal unit. The ratio of alkali-zeolite to ammonium nitrate solution was maintained to be 1:10. The alkali-zeolite and ammonium nitrate solution was aged vigorously at a stirring speed of 300 rpm to produce an ion-exchanged zeolite. To protonate the ion-exchanged zeolite, the ion-exchanged zeolite was heated via the second hydrothermal oven at a temperature of 80° C., for a time of 120 minutes, and at a stirring speed of 350 rpm. After the ion exchange and protonation steps were completed, the protonated zeolite powder was allowed to settle, and the liquid (without the protonated zeolite powder) was separated from purged from the system. Deionized water was used to wash the protonated zeolite powder by using ratio of protonated zeolite to water of 1:10 and aged vigorously, then the washing water was evacuated after the protonated zeolite powder settled. Finally, the protonated zeolite powder was concentrated and sent to the calcination unit for drying and calcination.

To dry the protonated zeolite powder, the protonated zeolite powder heated via an electrical heater at a heating ramp rate of 15° C./min to a temperature of 100° C. and held at that temperature for 10 hours. Then, to form the final boron-silicalite-1 sample, the protonated zeolite powder was calcined at a temperature of 550° C. and kept held at that temperature for a period of 5 hours. Then, the alkali-zeolite was cooled down to a temperature of 25° C.

### Example 3

In Example 3, the microscale boron-silicalite-1 of Example 1 was utilized.

The microscale catalyst utilized in this example comprised 40 wt. % boron-silicalite-1, having a silicon/boron ratio of 10, in 60 wt. % alumina binder. The catalyst was used in a reforming catalytic cracking process without hydrogen pressure to convert dodecane. The packed bed reactor heated by electrical heater adjusted at 350° C., and the feedstock was adjusted at liquid space velocity of 4 hourly. As shown subsequently in Table 1, the results produced aromatics in range of 30-33%, isomers 25-28% and naphthenes 6-7%.

TABLE 1
Reforming paraffin of dodecane by using boron-silicalite-1
in binder.

| | | |
|---|---|---|
| Reaction Time, min | 60 | 120 |
| Conversion % | 95 | 90 |
| Aromatic Yield (wt. %) | 33 | 30 |
| Iso-paraffins Yield (wt. %) | 28 | 25 |
| Olefins Yield (wt. % | 10 | 11 |
| Naphthenes Yield (wt. %) | 7 | 6 |
| Small Paraffins Yield (wt. %) | 20 | 20 |

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a composition or formulation should be appreciated as containing, in some embodiments, a mixture of isomers of that constituent. It should be appreciated that the examples supply compositional ranges for various compositions, and that the total amount of isomers of a particular chemical composition can constitute a range.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it should be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

What is claimed is:

1. A method for the production of microscale boron-silicalite-1, the method comprising:
combining a mineralizer agent, a templating agent, water, a silica compound, and boric acid in a first microwave unit;
heating the first microwave unit to form a boron-zeolite;
calcining the boron-zeolite to form an alkali-zeolite;
combining the alkali-zeolite with ammonium nitrate to produce an ion-exchanged zeolite;
heating the ion-exchanged zeolite to form a protonated zeolite; and
calcining the protonated zeolite to form the microscale boron-silicalite-1;
wherein the microscale boron-silicalite-1 has an average crystal size of from 1 micrometers to 5 micrometers when measured according to Scanning Electron Microscopy (SEM).

2. The method of claim 1, further comprising passing the alkali-zeolite to the first microwave unit, and wherein combining the alkali-zeolite with ammonium nitrate and heating the ion-exchanged zeolite occur in the first microwave unit.

3. The method of claim 1, further comprising passing the alkali-zeolite to a second microwave unit, and wherein combining the alkali-zeolite with ammonium nitrate and heating the ion-exchanged zeolite occur in the second microwave unit.

4. The method of claim 1, wherein the boron-zeolite is calcined at a calcination temperature from 500° C. to 600° C.

5. The method of claim 1, wherein the ion-exchanged zeolite is heated at an ion exchange temperature of from 65° C. to 90° C. with mixing at an ion exchange stirring speed of from 350 revolutions per minute (rpm) to 400 rpm.

6. The method of claim 1, wherein the first microwave unit heated to a crystallization temperature of from 165° C. to 185° C. and stirred at a crystallization stirring speed of from 250 revolutions per minute (rpm) to 350 rpm.

7. The method of claim 1, wherein the silica compound comprises colloidal silica.

8. The method of claim 1, wherein the mineralizer agent comprises sodium hydroxide, potassium hydroxide, or both.

9. The method of claim 1, further comprising washing the boron-zeolite.

10. The method of claim 1, further comprising washing the protonated zeolite.

11. A method for the production of boron-silicalite-1, the method comprising:
combining a templating agent, water, a silica compound and boric acid in a first hydrothermal unit;
heating the first hydrothermal unit to form a boron-zeolite;
calcining the boron-zeolite to form an alkali-zeolite;
combining the alkali-zeolite with ammonium nitrate to produce an ion-exchanged zeolite;
heating the ion-exchanged zeolite to form a protonated zeolite; and
calcining the protonated zeolite to form the boron-silicalite-1.

12. The method of claim 11, wherein the boron-silicalite-1 has an average crystal size of from 1 micrometers to 5 micrometers when measured according to Scanning Electron Microscopy (SEM).

13. The method of claim 11, wherein the boron-silicalite-1 has an average crystal size of from 200 nanometers to 400 nanometers when measured according to Scanning Electron Microscopy (SEM).

14. The method of claim 11, further comprising passing the alkali-zeolite to the first hydrothermal unit, and wherein combining the alkali-zeolite with ammonium nitrate and heating the ion-exchanged zeolite occur in the first hydrothermal unit.

15. The method of claim 11, further comprising passing the alkali-zeolite to a second hydrothermal unit, and wherein combining the alkali-zeolite with ammonium nitrate and heating the ion-exchanged zeolite occur in the second hydrothermal unit.

16. The method of claim 11, wherein the boron-zeolite is calcined at a calcination temperature from 500° C. to 600° C.

17. The method of claim 11, wherein the ion-exchanged zeolite is heated at an ion exchange temperature of from 65° C. to 90° C. with mixing at an ion exchange stirring speed of from 350 revolutions per minute (rpm) to 400 rpm.

18. The method of claim 11, further comprising washing the boron-zeolite.

19. The method of claim 11, further comprising washing the protonated zeolite.

20. The method of claim 11, further comprising combining a mineralizer agent with the templating agent, water, and boric acid in the first hydrothermal unit.
